(19) United States
(12) Patent Application Publication
(10) Pub. No.: US 2024/0193664 A1
(43) Pub. Date: Jun. 13, 2024

(54) SYSTEM AND METHOD FOR NOISE-RESISTANT COMPLEMENTARY ITEM RECOMMENDATION

(71) Applicant: Walmart Apollo, LLC, Bentonville, AR (US)

(72) Inventors: Luyi Ma, Sunnyvale, CA (US); Jianpeng Xu, Cupertino, CA (US); Hyun Duk Cho, San Francisco, CA (US); Evren Korpeoglu, San Jose, CA (US); Sushant Kumar, San Jose, CA (US); Kannan Achan, Saratoga, CA (US)

(21) Appl. No.: 18/072,155

(22) Filed: Nov. 30, 2022

(51) Int. Cl. G06Q 30/0601

(52) U.S. Cl. CPC G06Q 30/0631

(57) ABSTRACT

Systems and methods for providing noise-resistant complementary item recommendations are disclosed. A trained model is generated based on transaction data to represent each item of a set of items as a Gaussian distribution with a mean vector and a non-zero covariance matrix. An anchor item is to be displayed to a user via a user interface executed on a user device of the user, and is represented as a Gaussian distribution with an anchor mean vector and an anchor non-zero covariance matrix. A complementarity score for each item is computed based on a distance between the mean vector of the item and the anchor mean vector to generate a ranking for the set of items based on their respective complementarity scores. A plurality of top items are selected from the set of items based on the ranking as recommended complementary items, which are displayed with the anchor item on the user interface.

### TECHNICAL FIELD

This application relates generally to providing item recommendations and, more particularly, to systems and methods for providing noise-resistant complementary item recommendations.

### BACKGROUND

Item recommendation tasks in e-commerce industry are essential to improve user experiences by recommending related items to a query item. Different types of recommender systems are used to address use cases under various aspects of the relatedness, such as substitutional items (SI) recommendation and complementary items (CI) recommendation. In economics, a complementary item is a type of items whose appeal increases with the popularity of its complement. Therefore, complementary items usually have higher chances to be purchased together to complete the same shopping goal. For example, Shampoo and Conditioner are complementary to each other in order to fulfill the needs of shower supplies; similarly, TV and TV Mount are also complementary items for TV entertainment purposes. While SI recommendations have been extensively studied, complementary item recommender systems (CIRS) become increasingly important as they provide the customers with the opportunities to explore and interact with items that are complementary with what they have been interested in, and hence complete the customers' shopping journey by suggesting purchasing those items together.

Although the complementary relationship between items seems well-defined, it is impossible to gain the ground truth of the complementary relationship for all item pairs from the catalogue. To mitigate the labeling challenge, a common practice is to indicate the complementary relationship using the co-purchase signal of two items. These CIRS models usually represent each item as a vector under co-purchase space, and the similarity between the item vectors in the latent space reflects the frequency of co-purchases, and hence the assumed complementary relatedness.

However, co-purchased items are not necessarily complementary to each other. For example, certain popular items can appear in many transactions and hence be co-purchased frequently with items that are not complementary. Simply removing these popular items from all recommendations will hurt the results for item pairs with real complementary relations and decrease the business metrics (e.g., Gross Merchandise Value) of the recommender systems. One way is to annotate the co-viewed but not co-purchased item pairs as the negative labels and consider the co-purchased but not co-viewed item pairs as positive labels for learning. However, co-viewed data are noisy by themselves as well. Cleaning noisy labels with another noisy data source is not trustworthy in general. Identifying and cleaning co-purchased non-complementary items is not feasible due to the lack of ground truths.

Hence, it is challenging yet desirable to learn the real complementary relationships between items pairs and evaluate the recommendation results with the noisy labels.

### SUMMARY

The embodiments described herein are directed to systems and methods for providing noise-resistant complementary item recommendations.

In various embodiments, a system including a non-transitory memory configured to store instructions thereon and at least one processor is disclosed. The at least one processor is configured to read the instructions to: generate a trained model based on transaction data identifying a plurality of transactions of a plurality of users, represent each item of a set of items as an item embedding in an embedding space based on the trained model, wherein the item embedding is a Gaussian distribution with a mean vector and a non-zero covariance matrix, determine an anchor item to be displayed to a user via a user interface executed on a user device of the user, represent the anchor item as an anchor embedding in the embedding space based on the trained model, wherein the anchor embedding is a Gaussian distribution with an anchor mean vector and an anchor non-zero covariance matrix, compute a complementarity score for each item of the set of items, based on a distance between the mean vector of the item and the anchor mean vector, generate a ranking for the set of items based on their respective complementarity scores, select a plurality of top items in the set of items based on the ranking as recommended complementary items, and transmit information about the recommended complementary items to the user device to be displayed with the anchor item on the user interface.

In various embodiments, a computer-implemented method is

disclosed. The computer-implemented method includes steps of: generating a trained model based on transaction data identifying a plurality of transactions of a plurality of users; representing each item of a set of items as an item embedding in an embedding space based on the trained model, wherein the item embedding is a Gaussian distribution with a mean vector and a non-zero covariance matrix; determining an anchor item to be displayed to a user via a user interface executed on a user device of the user; representing the anchor item as an anchor embedding in the embedding space based on the trained model, wherein the anchor embedding is a Gaussian distribution with an anchor mean vector and an anchor non-zero covariance matrix; computing a complementarity score for each item of the set of items, based on a distance between the mean vector of the item and the anchor mean vector; generating a ranking for the set of items based on their respective complementarity scores; selecting a plurality of top items in the set of items based on the ranking as recommended complementary items; and transmitting information about the recommended complementary items to the user device to be displayed with the anchor item on the user interface.

In various embodiments, a non-transitory computer readable medium having instructions stored thereon is disclosed. The instructions, when executed by at least one processor, cause a device to perform operations including: generating a trained model based on transaction data identifying a plurality of transactions of a plurality of users; representing each item of a set of items as an item embedding in an embedding space based on the trained model, wherein the item embedding is a Gaussian distribution with a mean vector and a non-zero covariance matrix; determining an anchor item to be displayed to a user via a user interface executed on a user device of the user; representing the anchor item as an anchor embedding in the embedding space based on the trained model, wherein the anchor embedding is a Gaussian distribution with an anchor mean vector and an anchor non-zero covariance matrix; computing a complementarity score for each item of the set of items, based on a distance between the mean vector of the item and the anchor mean vector; generating a ranking for the set of items based on their respective complementarity scores; selecting a plurality of top items in the set of items based on the ranking as recommended complementary items; and transmitting information about the recommended complementary items to the user device to be displayed with the anchor item on the user interface.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a block diagram of an item recommendation system that includes an item recommendation computing device, in accordance with some embodiments of the present teaching.

FIG. 2 is a block diagram of an item recommendation computing device, in accordance with some embodiments of the present teaching.

FIG. 3 is a block diagram illustrating various portions of an item recommendation system, in accordance with some embodiments of the present teaching.

FIG. 4 is a block diagram illustrating various portions of an item recommendation computing device, in accordance with some embodiments of the present teaching.

FIG. 5 is a flowchart illustrating a method for complementary item recommendations, in accordance with some embodiments of the present teaching.

FIG. 6 is a flowchart illustrating an exemplary method that can be carried out by an item recommendation computing device, in accordance with some embodiments of the present teaching.

FIG. 7 is a flowchart illustrating another exemplary method that can be carried out by an item recommendation computing device, in accordance with some embodiments of the present teaching.

FIG. 8A and FIG. 8B illustrate a process for training an embedding model for noise-resistant item recommendation, in accordance with some embodiments of the present teaching.

FIG. 9A shows a visualization of Gaussian embeddings for different items, in accordance with some embodiments of the present teaching.

FIG. 9B shows a visualization of Gaussian embeddings for co-purchase item pairs, in accordance with some embodiments of the present teaching.

FIG. 10A shows an exemplary distribution of Chi-squared statistics of positive and negative dependent labels with p-value=0.05, in accordance with some embodiments of the present teaching.

FIG. 10B shows an exemplary distribution of Chi-squared statistics of positive and negative dependent labels with p-value=0.01, in accordance with some embodiments of the present teaching.

FIG. 10C shows an exemplary distribution of Chi-squared statistics of positive and negative dependent labels with p-value=0.001, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Providing complementary item recommendations is a popular technique in e-commerce to boost sales of the complementary items that customers may want but forget to find before the customers check out. A complementary item recommender system (CIRS) recommends the complementary items for a given query item. Existing CIRS models consider the item co-purchase signal as a proxy of the complementary relationship, due to the lack of human-curated labels from the huge transaction records. However, co-purchased items (in a same transaction or a same basket) are not necessarily complementary to each other. For example, customers may frequently purchase bananas and bottle water within the same transaction, but these two items are not complementary. Hence, using co-purchase signals directly as labels will aggravate the model performance. In addition, model evaluation will not be trustworthy if the labels for evaluation are not reflecting the true complementary relatedness.

To address the above challenges from noisy labeling of the co-purchase data, the present teaching discloses systems and methods to model the co-purchases of two items as a Gaussian distribution, where its mean denotes the co-purchases from the complementary relatedness, and its covariance denotes the co-purchases from the noise. In some embodiments, the system represents each item as a Gaussian embedding and parameterizes the Gaussian distribution of co-purchases by the means and covariances from item Gaussian embedding. To reduce the impact of the noisy labels during evaluation, the system can utilize an independence test-based method to generate a trustworthy label set with certain confidence.

In some embodiments, to address the noisy label issue during a training of a model for item recommendation, one can assume that the co-purchases of items are composed by two components: (a) co-purchases motivated by the true complementary relationships, and (b) co-purchases from other motivations (e.g., the noise). The system may directly model component (a) by the similarities or distances of item embeddings under the complementary space, and model component (b) by the variance around (a). Hence, the co-purchase data can be assumed as a Gaussian distribution, where the mean is the co-purchases from the true complementary, and the variance is the co-purchases from the noise. To achieve this, instead of representing items as item embeddings under point estimation, the system employs Gaussian embeddings with a mean vector and a covariance matrix as item representations. The Gaussian distribution of the co-purchase data can be naturally parameterized by the item Gaussian embeddings and fit into the noisy co-purchase data by optimizing the expected likelihood between Gaussian embeddings.

In some embodiments, to address the noisy label issue during evaluation of a trained model for item recommendation, the system uses an independence test-based method to surface the item pairs with more complementarity as positive labels for evaluation. Given a pair of co-purchased items, the purchase of an individual item can be treated as a binary random variable to study the difference between observed co-purchase frequency and the expected co-purchase frequency under the independence assumption via Chi-squared independence test. Based on the definition of complementary items in economics, the purchases of them should be dependent and the observed co-purchase frequency should be larger than the expected independent co-purchase frequency due to the synergy effect between complementary items. A set of co-purchase labels could be generated for evaluation by providing a predefined p-value, which controls the certainty of the label selection from the noisy observation. Although it is promising in some embodiments to use the selected label as the ground truth labels for training as well, the coverage of this set over the item catalogue is very limited and hence not feasible to be generalized for training purpose in other embodiments.

Embodiments of the present teaching are disclosed to: learn complementary items for a given anchor item to customers in a scalable way, and to extract more labels and training dataset for scalable training, inference and evaluation. In some embodiments, the trained CIRS model is a label Noise-rEsistAnT model named NEAT, which learns the complementary relationship by Gaussian embedding representation. In order to accurately evaluate the model performance, a trustworthy label set with controllable confidence via an independence test.

Furthermore, in the following, various embodiments are described with respect to methods and systems for providing noise-resistant complementary item recommendations. In some embodiments, a trained model is generated based on transaction data to represent each item of a set of items as a Gaussian distribution with a mean vector and a non-zero covariance matrix. An anchor item is to be displayed to a user via a user interface executed on a user device of the user, and is represented as a Gaussian distribution with an anchor mean vector and an anchor non-zero covariance matrix. A complementarity score for each item is computed based on a distance between the mean vector of the item and the anchor mean vector to generate a ranking for the set of items based on their respective complementarity scores. For example, a smaller distance could mean a higher complementarity score and a stronger complementarity. A plurality of top items are selected from the set of items based on the ranking as recommended complementary items, which are displayed with the anchor item on the user interface.

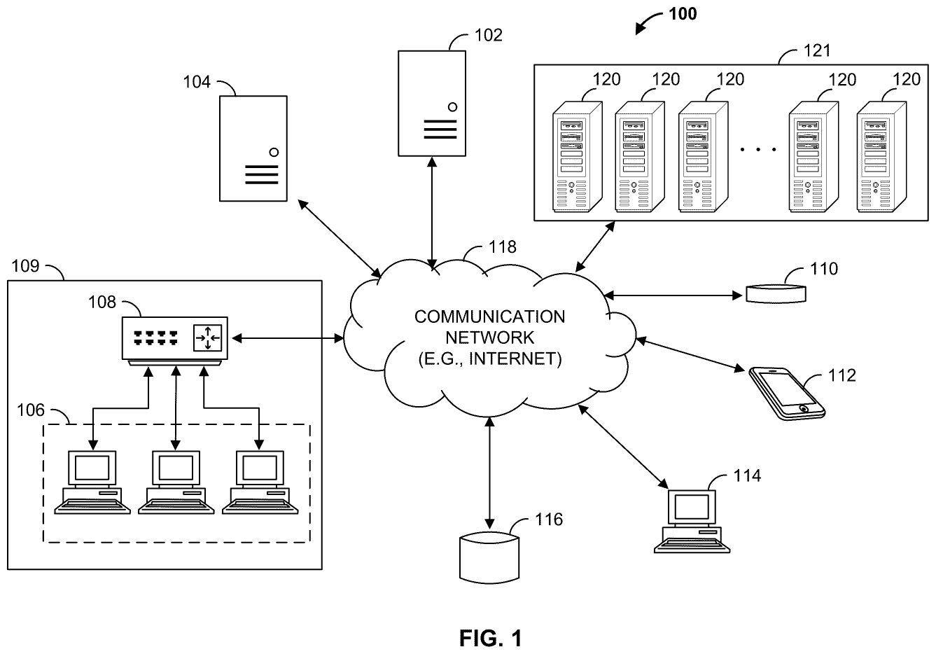

Turning to the drawings, FIG. 1 illustrates a block diagram of an item recommendation system 100 that includes an item recommendation computing device 102 (e.g., a server, such as an application server), a web server 104, one or more processing devices 120, workstation(s) 106, database 116, and one or more customer computing devices 110, 112, 114 operatively coupled over network 118. The item recommendation computing device 102, web server 104, workstation(s) 106, processing device(s) 120, and multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over communication network 118.

In some examples, each of the item recommendation computing device 102 and processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of one or more processing devices 120 are offered as a cloud-based service (e.g., cloud computing). For example, cloud-based network 121 may offer computing and storage resources of one or more processing devices 120 to item recommendation computing device 102.

In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, web server 104 hosts one or more retailer websites. In some examples, the item recommendation computing device 102, processing devices 120, and/or web server 104 are operated by a retailer, and multiple customer computing devices 110, 112, 114 are operated by customers of the retailer. In some examples, processing devices 120 are operated by a third party (e.g., a cloud-computing provider).

Workstation(s) 106 are operably coupled to communication network 118 via router (or switch) 108. Workstation(s) 106 and/or router 108 may be located at a store 109, for example. Workstation(s) 106 can communicate with item recommendation computing device 102 over communication network 118. The workstation(s) 106 may send data to, and receive data from, item recommendation computing device 102. For example, the workstation(s) 106 may transmit data identifying items purchased by a customer at store 109 to item recommendation computing device 102.

Although FIG. 1 illustrates three customer computing devices 110, 112, 114, item recommendation system 100 can include any number of customer computing devices 110, 112, 114. Similarly, item recommendation system 100 can include any number of item recommendation computing devices 102, processing devices 120, workstations 106, web servers 104, and databases 116.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Each of the first customer computing device 110, second customer computing device 112, and Nth customer computing device 114 may communicate with web server 104 over communication network 118. For example, each of multiple computing devices 110, 112, 114 may be operable to view, access, and interact with a website, such as a retailer's website, hosted by web server 104. Web server 104 may transmit user session data related to a customer's activity (e.g., interactions) on the website. For example, a customer may operate one of customer computing devices 110, 112, 114 to initiate a web browser that is directed to the website hosted by web server 104. The customer may, via the web browser, view item advertisements for items displayed on the website, and may click on item advertisements, for example. The website may capture these activities as user session data, and transmit the user session data to item recommendation computing device 102 over communication network 118. The website may also allow the operator to add one or more of the items to an online shopping cart, and allow the customer to perform a “checkout” of the shopping cart to purchase the items. In some examples, web server 104 transmits purchase data identifying items the customer has purchased from the website to item recommendation computing device 102.

In some examples, item recommendation computing device 102 may execute one or more models (e.g., algorithms), such as a machine learning model, statistical model, etc., to determine recommended items to advertise to the customer (i.e., item recommendations). Item recommendation computing device 102 may transmit the item recommendations to web server 104 over communication network 118, and web server 104 may display advertisements for one or more of the recommended items on the website to the customer. For example, web server 104 may display the recommended items to the customer on a homepage, a catalog webpage, an item webpage, or a search results webpage of the website (e.g., as the customer browses those respective webpages).

In some examples, web server 104 transmits a recommendation request to item recommendation computing device 102. The recommendation request may be sent together with a search query provided by the customer (e.g., via a search bar of the web browser), or a standalone recommendation query provided by a processing unit in response to user adding one or more items to cart or interacting (e.g., engaging) with one or more items.

In one example, a customer selects an item on a website hosted by the web server 104, e.g. by clicking on the item to view its product description details, by adding it to shopping cart, or by purchasing it. The web server 104 may treat the item as an anchor item or query item for the customer, and send a recommendation request to the item recommendation computing device 102. In response to receiving the request, item recommendation computing device 102 may execute the one or more processors to determine recommended items that are complementary to the anchor item, and transmit the recommended items to the web server 104 to be displayed together with the anchor item to the customer.

In another example, a customer submits a search query on a website hosted by the web server 104, e.g. by entering a query in a search bar. The web server 104 may send a recommendation request to the item recommendation computing device 102. In response to receiving the request, item recommendation computing device 102 may execute the one or more processors to first determine search results including items matching the search query, and then determine recommended items that are complementary to one or more top items in the search results. The item recommendation computing device 102 may transmit the recommended items to the web server 104 to be displayed together with the search results to the customer.

Item recommendation computing device 102 may transmit recommended items to web server 104 over communication network 118. Web server 104 may display the recommended items on a search results webpage, or on a product description webpage regarding an anchor item.

Item recommendation computing device 102 is further operable to communicate with database 116 over communication network 118. For example, item recommendation computing device 102 can store data to, and read data from, database 116. Database 116 can be a remote storage device, such as a cloud-based server, a disk (e.g., a hard disk), a memory device on another application server, a networked computer, or any other suitable remote storage. Although shown remote to item recommendation computing device 102, in some examples, database 116 can be a local storage device, such as a hard drive, a non-volatile memory, or a USB stick. Item recommendation computing device 102 may store purchase data received from web server 104 in database 116. Item recommendation computing device 102 may also receive from web server 104 user session data identifying events associated with browsing sessions, and may store the user session data in database 116.

In some examples, item recommendation computing device 102 generates feature vectors for a plurality of models (e.g., machine learning models, statistical models, algorithms, etc.) based on historical user session data, purchase data, and current user session data for the user. Item recommendation computing device 102 trains the models based on their corresponding feature vectors, and item recommendation computing device 102 stores the models in a database, such as in database 116 (e.g., cloud storage).

The models, when executed by item recommendation computing device 102, allow item recommendation computing device 102 to determine item recommendations for one or more items to advertise to a customer. For example, item recommendation computing device 102 may obtain the models from database 116. Item recommendation computing device 102 may then receive, in real-time from web server 104, current user session data identifying real-time events of the customer interacting with a website (e.g., during a browsing session). In response to receiving the user session data, item recommendation computing device 102 may execute the models to determine item recommendations for items to display to the customer.

In some examples, item recommendation computing device 102 receives current user session data from web server 104. The user session data may identify actions (e.g., activity) of the customer on a website. For example, the user session data may identify item impressions, item clicks, items added to an online shopping cart, conversions, click-through rates, advertisements viewed, and/or advertisements clicked during an ongoing browsing session (e.g., the user data identifies real-time events).

In some examples, the item recommendation computing device 102 may train a recommendation model to put or embed items in a high-dimensional space, where each item is embedded as a high-dimensional Gaussian distribution having a mean vector and a covariance matrix. The item recommendation computing device 102 can use a distance between mean vectors of two items' Gaussian distributions to represent complementarity of the two items, where a closer distance means a stronger complementarity. This can be used to score and rank complementary items, to be selected for display with the query or anchor item. In some examples, the item recommendation computing device 102 can rank the recommended items based on their respective complementarity scores with respect to the anchor item, utilizing a ranking model. For example, a higher complementarity score means a closer distance between the mean vector of the recommended item's Gaussian distribution and the mean vector of the anchor item's Gaussian distribution. In some examples, the complementarity score may take into consideration of the particular user's information, e.g. based on user session data, in addition to the mean vector distances.

In some examples, the item recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units.

Based on the output of the models, item recommendation computing device 102 may generate ranked item recommendations for items to be displayed on the website. For example, item recommendation computing device 102 may transmit the item recommendations to web server 104, and web server 104 may display the recommended items to the customer together with an anchor item selected by the customer.

Among other advantages, the embodiments allow for more accurate complementary item recommendations for an anchor item interesting to a customer. By adding Gaussian distribution with variance and noise consideration into a machine learning model for complementary item recommendation, the trained recommendation model provides significant more effectiveness than existing recommendation models. In addition, trustworthy labels are generated without extra data to provide an efficient and effective evaluation and/or update of the trained model.

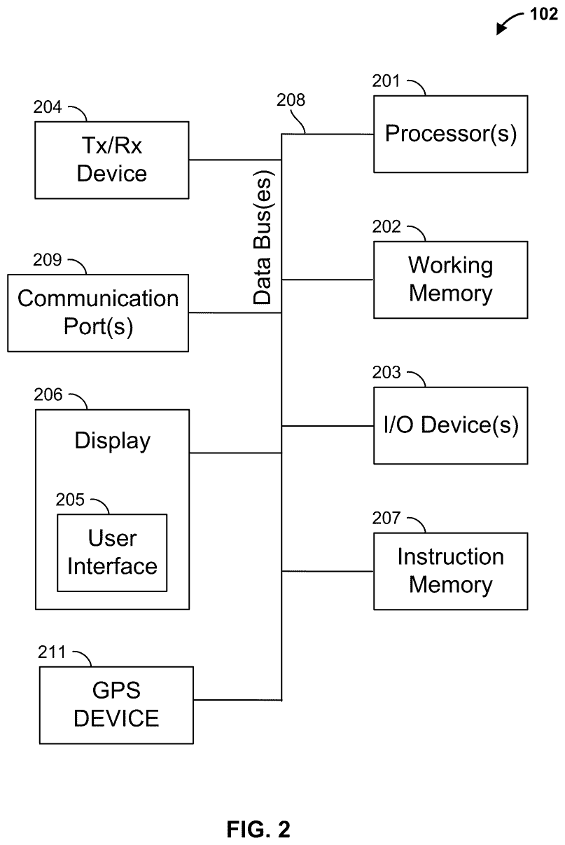

FIG. 2 illustrates a block diagram of an item recommendation computing device, e.g. the item recommendation computing device 102 of FIG. 1, in accordance with some embodiments of the present teaching. In some embodiments, each of the item recommendation computing device 102, the web server 104, the workstation(s) 106, the multiple customer computing devices 110, 112, 114, and the one or more processing devices 120 in FIG. 1 may include the features shown in FIG. 2. Although FIG. 2 is described with respect to the item recommendation computing device 102. It should be appreciated, however, that the elements described can be included, as applicable, in any of the item recommendation computing device 102, the web server 104, the workstation(s) 106, the multiple customer computing devices 110, 112, 114, and the one or more processing devices 120.

Item recommendation computing device 102 can include one or more processors 201, working memory 202, one or more input/output devices 203, instruction memory 207, a transceiver 204, one or more communication ports 209, a display 206 with a user interface 205, and an optional global positioning system (GPS) device 211, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 201 can be configured to perform a certain function or operation by executing code, stored on instruction memory 207, embodying the function or operation. For example, processors 201 can be configured to execute code stored in instruction memory 207 to perform one or more of any function, method, or operation disclosed herein.

Additionally processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of item recommendation computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as machine learning model training data.

Display 206 can be any suitable display, and may display user interface 205. User interfaces 205 can enable user interaction with item recommendation computing device 102. For example, user interface 205 can be a user interface for an application of a retailer that allows a customer to view and interact with a retailer's website. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 item recommendation computing device 102 will be operating in. Processor(s) 201 is operable to receive data from, or send data to, a network, such as communication network 118 of FIG. 1, via transceiver 204.

GPS device 211 may be communicatively coupled to the GPS and operable to receive position data from the GPS. For example, GPS device 211 may receive position data identifying a latitude, and longitude, from a satellite of the GPS. Based on the position data, item recommendation computing device 102 may determine a local geographical area (e.g., town, city, state, etc.) of its position. Based on the geographical area, item recommendation computing device 102 may determine relevant trend data (e.g., trend data identifying events in the geographical area).

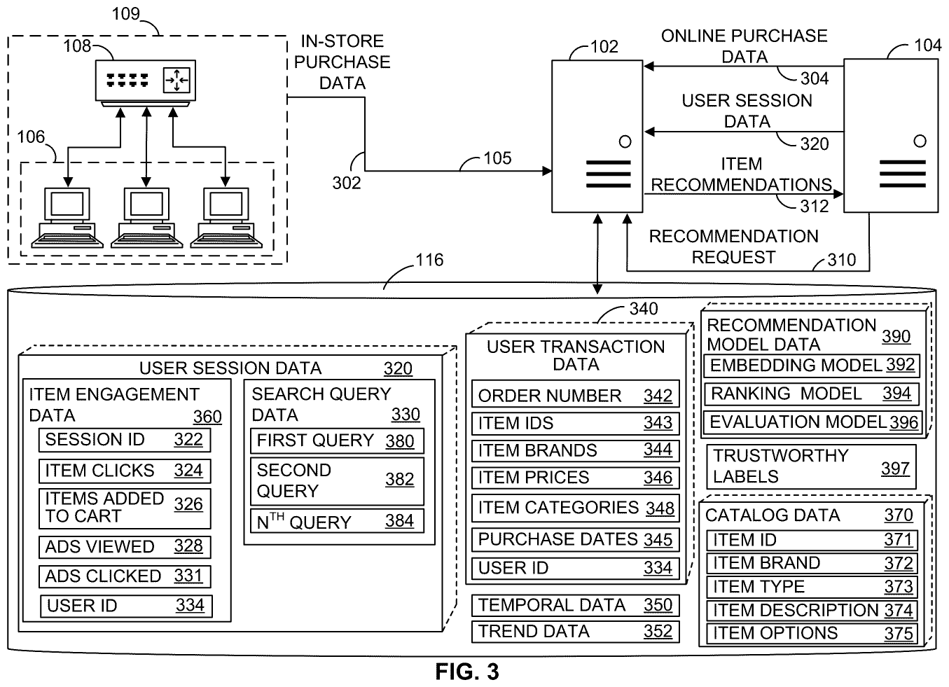

FIG. 3 is a block diagram illustrating examples of various portions of an item recommendation system, e.g. the item recommendation system 100 of FIG. 1, in accordance with some embodiments of the present teaching. As indicated in FIG. 3, the item recommendation computing device 102 may receive user session data 320 from web server 104, and store user session data 320 in database 116. User session data 320 may identify, for each user (e.g., customer), data related to that user's browsing session, such as when browsing a retailer's webpage hosted by web server 104.

In this example, user session data 320 may include item engagement data 360 and/or search query data 330. Item engagement data 360 may include one or more of a session ID 322 (i.e., a website browsing session identifier), item clicks 324 identifying items which a user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 331 identifying advertisements the user clicked on, and user ID 334 (e.g., a customer ID, retailer website login ID, a cookie ID, etc.).

Search query data 330 may identify one or more searches conducted by a user during a browsing session (e.g., a current browsing session). For example, item recommendation computing device 102 may receive a recommendation request 310 from web server 104, where the recommendation request 310 may be associated with a search request that identifies one or more search terms provided by the user. Item recommendation computing device 102 may store the search terms as provided by the user as search query data 330. In this example, search query data 330 includes first query 380, second query 382, and Nth query 384.

Item recommendation computing device 102 may also receive online purchase data 304 from web server 104, which identifies and characterizes one or more online purchases, such as purchases made by the user and other users via a retailer's website hosted by web server 104. Item recommendation computing device 102 may also receive in-store purchase data 302 from store 109, which identifies and characterizes one or more in-store purchases.

Item recommendation computing device 102 may parse in-store purchase data 302 and online purchase data 304 to generate user transaction data 340. In this example, user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item types 348 identifying a type (e.g., category) of each item purchased, a purchase date 345 identifying the purchase date of the purchase order, and user ID 334 for the user making the corresponding purchase.

Database 116 may further store catalog data 370, which may identify one or more attributes of a plurality of items, such as a portion of or all items a retailer carries. Catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

Database 116 may also store recommendation model data 390 identifying and characterizing one or more machine learning models. For example, recommendation model data 390 may include an embedding model 392, a ranking model 394, and an evaluation model 396. Each of the embedding model 392, the ranking model 394, and the evaluation model 396 may be machine learning models trained based on co-purchase item pairs generated by item recommendation computing device 102.

Database 116 may further store temporal data 350 and trend data 352. Temporal data 350 may identify a current date (e.g., a date range), a current season (e.g., shopping season), or any other suitable time period. Trend data 352 may identify current events (e.g., local current events) such as sporting events, festivals, weather changes, seasonal changes, natural disasters. Temporal data 350 and trend data 352 may further help item recommendation computing device 102 determine user intent. For example, when a temporal data 350 for current user session matches a festival or holiday shopping season, the user intent may be determined to be holiday decorations when the current user session indicates user interaction with decorative items (e.g., ornaments, candles).

In some examples, database 116 may further store trustworthy labels 397. Trustworthy labels 397 may include co-purchase item pairs that are validated as trustworthy based on a Chi-squared test and calculations of co-purchase frequency and expected frequency under independence assumption. As such, the trustworthy labels 397 may be utilized by the evaluation model 396 for evaluation of the embedding model 392 and the ranking model 394.

In some examples, item recommendation computing device 102 receives (e.g., in real-time) user session data 320 for a customer interacting with a website hosted by web server 104. In response, item recommendation computing device 102 generates item recommendation 312 identifying recommended items to advertise to the customer, and transmits item recommendation 312 to web server 104.

In some examples, the recommendation request 310 may be associated with an anchor item or query item to be displayed to a user, e.g. after the user chooses the anchor item from a search results webpage, or after the user clicks on an advertisement or promotion related to the anchor item. In response, the item recommendation computing device 102 generates recommended items that are complementary to the anchor item, based on the embedding model 392. Then, the item recommendation computing device 102 may provide a ranking of the recommended items based on the ranking model 394, and transmit the top K recommended items as the item recommendation 312 to the web server 104 for displaying the top K recommended items together with the anchor item to the user, where K may be a predetermined positive integer.

In some examples, the item recommendation computing device 102 may utilize the evaluation model 396 to evaluate and/or update the embedding model 392 and the ranking model 394 based on trustworthy labels 397. For example, for each item pair (q, v) in the trustworthy labels 397, the item recommendation computing device 102 may compute the top K complementary items for the item q based on the embedding model 392 and the ranking model 394, and compute metrics to evaluate the performance of the embedding model 392 and the ranking model 394 when the item v is in the top K complementary items for the item q. The item recommendation computing device 102 may aggregate the metrics over all labels to evaluate performance of the embedding model 392 and the ranking model 394.

In some embodiments, the item recommendation computing device 102 may assign each of the embedding model 392, the ranking model 394, and the evaluation model 396 (or parts thereof) to a different processing unit or virtual machines hosted by one or more processing devices 120. Further, item recommendation computing device 102 may obtain the outputs of the embedding model 392, ranking model 394, and/or evaluation model 396 from the processing units, and generate the item recommendation 312 based on the outputs of the models.

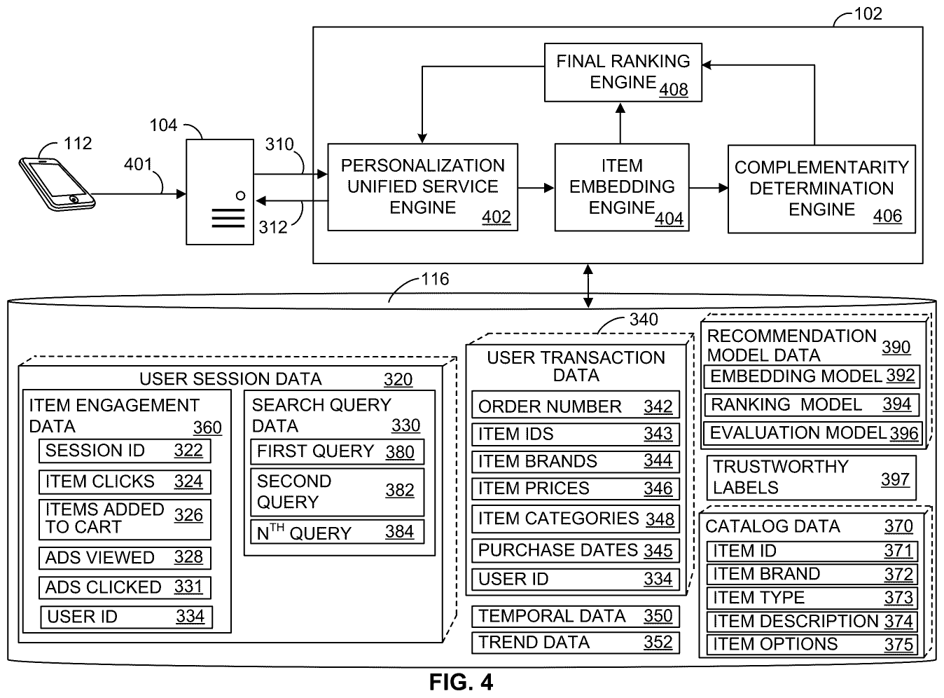

FIG. 4 is a block diagram illustrating a more detailed view of an item recommendation computing device, e.g. the item recommendation computing device 102 in FIG. 1, in accordance with some embodiments of the present teaching. As shown in FIG. 4, the item recommendation computing device 102 includes a personalization unified service engine 402, an item embedding engine 404, a complementarity determination engine 406, and a final ranking engine 408. In some examples, one or more of the personalization unified service engine 402, the item embedding engine 404, the complementarity determination engine 406 and the final ranking engine 408 are implemented in hardware. In some examples, one or more of personalization unified service engine 402, item embedding engine 404, complementarity determination engine 406 and final ranking engine 408 are implemented as an executable program maintained in a tangible, non-transitory memory, such as instruction memory 207 of FIG. 2, which may be executed by one or processors, such as processor 201 of FIG. 2.

For example, the personalization unified service engine 402 may obtain from the web server 104 a recommendation request 310 as a message 401 is sent from the user device 112 to the web server 104, and may execute recommendation model(s) included in the recommendation model data 390. The message 401 sent by the user using the user device 112 may indicate a search query or an anchor item chosen by the user. The recommendation request 310 may either include information about the anchor item, or indicate the anchor item in the user session data 320. In some embodiments, the recommendation request 310 is to seek one or more recommended items that are complementary to the anchor item. When the recommendation request 310 indicates a search query, the item recommendation computing device 102 may treat one or more top items matching the search query as the anchor item for complementary item recommendation.

In this example, web server 104 transmits a recommendation request 310 to item recommendation computing device 102. The recommendation request 310 may include a request for item recommendations for presentation to a particular user using the user device 112. In some examples, recommendation request 310 further identifies a user (e.g., customer) for whom the item recommendations are requested at web server 104. Personalization unified service engine 402 receives recommendation request 310, and receives and parses the user session data 320 (e.g., user session data associated with a current user session of the user in real-time). Personalization unified service engine 402 provides to the item embedding engine 404 the user session data 320, and other data, which may include the user transaction data 340, and user session data 320 (e.g., user session data from historical user sessions) extracted from database 116.

In some embodiments, the item embedding engine 404 can obtain the embedding model 392 from the database 116, where the embedding model 392 is a trained model based on transaction data identifying a plurality of transactions of a plurality of users of the website hosted by the web server 104. The item embedding engine 404 may determine the anchor item to be displayed to the user via a user interface executed on a user device 112 of the user, and represent the anchor item as an anchor embedding in an embedding space based on the embedding model 392, where the anchor embedding is a Gaussian distribution with an anchor mean vector and an anchor non-zero covariance matrix. For example, the Gaussian distribution may be a d-dimensional Gaussian distribution in a d-dimensional embedding space, where d is a positive integer.

In some embodiments, the item embedding engine 404 can represent each item, in a set of items associated with the website hosted by the web server 104, as an item embedding in the embedding space based on the embedding model 392. The item embedding for each item may be a Gaussian distribution with a mean vector and a non-zero covariance matrix. In some embodiments, the mean vector of each item represents a location of the item in the embedding space with a maximum density; and the non-zero covariance matrix of each item represents a non-zero variation in a co-purchase behavior of the item. In some embodiments, the item embeddings for the set of items can be performed during a training process of the embedding model 392, or after the training process but before receiving the recommendation request 310. As such, these pre-performed item embeddings can be stored in the database 116, and be retrieved by the item embedding engine 404.

In some embodiments, the complementarity determination engine 406 can compute a complementarity score for each item with respect to the anchor item. For example, the complementarity determination engine 406 may compute a complementarity score for each item of the set of items, based on a distance between the mean vector of the item and the anchor mean vector obtained from the item embedding engine 404, utilizing the ranking model 394 stored in the database 116. For example, a smaller distance means a higher complementarity score and a stronger complementarity. The complementarity determination engine 406 may send the complementarity scores to the final ranking engine 408.

In some embodiments, the final ranking engine 408 can generate a ranking for the set of items based on their respective complementarity scores. In some embodiments, the final ranking engine 408 may only rank items whose complementarity scores are higher than a threshold. The final ranking engine 408 may select a plurality of top items from the set of items or the ranked items based on their complementarity scores. The final ranking engine 408 may generate the item recommendations 312 as an order list of the plurality of top items, and generate data that identifies the order of item recommendations 312 associated with the particular user to optimize user interactions with and user purchases of items in the recommendations.

The personalization unified service engine 402 may receive the item recommendations 312 from the final ranking engine 408 in a data format (e.g., message) acceptable by web server 104. Personalization unified service engine 402 transmits the item recommendations 312 to web server 104. The web server 104 may then update or generate item recommendations for presentation to the user via the user device 112 based on the item recommendations 312. For example, the item recommendations may be displayed together with the anchor item on the user interface.

In some embodiments, the item recommendation computing device 102 may generate the embedding model 392 with a training process based on transaction data identifying a plurality of transactions. For example, the item recommendation computing device 102 can generate a plurality of positive item pairs based on a plurality of co-purchase item pairs from the plurality of transactions. In some embodiments, each of the plurality of co-purchase item pairs is a heterogeneous item pair including two items belonging to two different products respectively. In some embodiments, the training process may be performed by one or more of the item embedding engine 404, the complementarity determination engine 406, the final ranking engine 408 in the item recommendation computing device 102.

During a training process, for each positive item pair (q, v) and each user u of the plurality of users, the item recommendation computing device 102 can generate a triplet (q, v, u) and its corresponding negative samples (q′, v′), where q represents a query item in the positive item pair, v represents a recommendation item in the positive item pair, q′ represents an item that is not purchased by u, v′ represents an item that is not co-purchased with q by u.

At the beginning of the training, the item recommendation computing device 102 may generate an initial item embedding for each item of the set of items as a Gaussian distribution with a random mean vector and a random covariance matrix. A total loss function may be computed based on item embeddings for each triplet (q, v, u) and its corresponding negative samples (q′, v′). By minimizing the total loss function, the item recommendation computing device 102 can find an optimized mean vector and an optimized covariance matrix for each item of the set of items, and store the optimized mean vectors and optimized covariance matrices associated with the embedding model 392 in the database 116. As such, these optimized parameters may be retrieved by the item recommendation computing device 102 directly or computed by the item recommendation computing device 102 based on the embedding model 392.

In some embodiments, for each positive item pair (q, v) and its corresponding negative sample v′, the item recommendation computing device 102 can compute a first expected likelihood as an inner product of two item embeddings of items q and v, and a second expected likelihood as an inner product of two item embeddings of items q and v′. Then based on the first expected likelihood and the second expected likelihood, the item recommendation computing device 102 can compute a max-margin loss function with a predetermined margin for each positive item pair (q, v) and its corresponding negative sample v′. The total loss function may be computed based on the max-margin loss functions for every user, every positive item pair (q, v) and its corresponding negative sample v′.

In some embodiments, for each user u, each query item q, and its corresponding negative sample q′, the item recommendation computing device 102 can compute a first personalization loss function based on (u, q, q′). For each user u, each recommendation item v, and its corresponding negative sample v′, the item recommendation computing device 102 can compute a second personalization loss function based on (u, v, v′). The total loss function may be computed based on a summation of: the max-margin loss function, the first personalization loss function and the second personalization loss function.

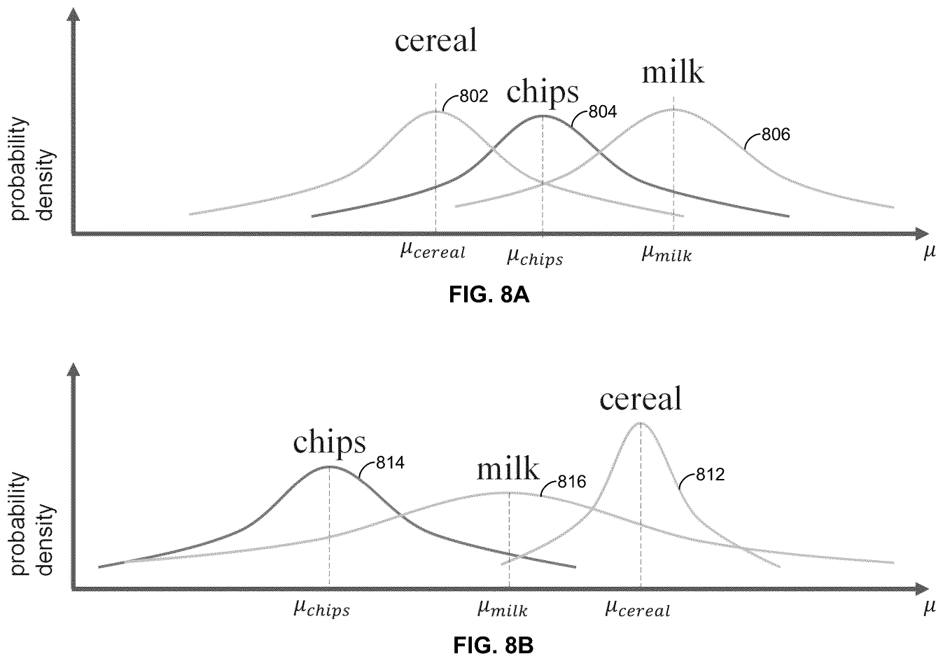

FIG. 8A and FIG. 8B illustrate a process for training item embedding models, e.g. the embedding model 392 and the ranking model 394, for noise-resistant item recommendation, in accordance with some embodiments of the present teaching. FIG. 8A shows the initialized item embeddings for three items: cereal, chips and milk. Each initialized item embedding is a Gaussian distribution with a randomly assigned mean and randomly assigned covariance. These initialized item embeddings 802, 804, 806 cannot capture the complementary relationships of these items.

FIG. 8B shows the trained item embeddings for three items: cereal, chips and milk. As shown in FIG. 8B, after the training or learning process as discussed above based on the positive and negative samples, the position for the mean vector of the Gaussian distribution of each item is updated. In addition, the covariance matrices are learned to reflect variance of co-purchases. For example, the trained Gaussian distribution 816 for milk has the largest covariance among the three items, while the trained Gaussian distribution 812 for cereal has the smallest covariance among the three items. In some embodiments, this reflects that based on the co-purchase data, milk is most likely to be co-purchased with another item, and cereal is least likely to be co-purchased with another item, among the three items.

In some embodiments, the item recommendation computing device 102 may generate the trustworthy labels 397 for evaluation of the embedding model 392. For example, the item recommendation computing device 102 can generate a plurality of positive item pairs based on a plurality of co-purchase item pairs from the plurality of transactions, where each of the plurality of co-purchase item pairs is a heterogeneous item pair including two items belonging to two different products respectively. In some embodiments, a purchase of each individual item is represented by a random variable following a Bernoulli distribution. In some embodiments, the trustworthy labels 397 can be generated using one or more of the personalization unified service engine 402, the item embedding engine 404, the complementarity determination engine 406, the final ranking engine 408 in the item recommendation computing device 102.

To generate the trustworthy labels 397, for each positive item pair (vi, vj), the item recommendation computing device 102 can compute: a first frequency of co-purchases of items vi and vj, a second frequency of co-purchases including item vi, and a third frequency of co-purchases including item vj. Then the item recommendation computing device 102 can compute a contingency table based on: the first frequency, the second frequency and the third frequency; and compute an expectation table based on: a total number of observed co-purchases in the plurality of transactions, the second frequency and the third frequency. The item recommendation computing device 102 can then compute a value of a Chi-squared statistics based on the contingency table and the expectation table, and compare the value to a threshold. In some examples, the threshold may be associated with a p-value of a Chi-squared distribution with one degree of freedom. The item recommendation computing device 102 may also compare the first frequency to an expected frequency under an independence assumption. When the value is larger than the threshold and when the first frequency is larger than the expected frequency, the item recommendation computing device 102 can determine that the positive item pair (vi, vj) is a labeled item pair that is trustworthy for evaluation of the embedding model 392. As such, the item recommendation computing device 102 can generate a set of labeled item pairs as the trustworthy labels 397, and store them in the database 116.

In some embodiments, the item recommendation computing device 102 can evaluate the embedding model 392 and the ranking model 394 based on the trustworthy labels 397. For each labeled item pair (ql, vl), the item recommendation computing device 102 can compute top K complementary items for the item ql based on the embedding model 392 and the ranking model 394, where K is a positive integer, and compute metrics to evaluate the trained models when the item vl is among the top K complementary items. The item recommendation computing device 102 can aggregate the metrics over all labeled item pairs of the trustworthy labels 397 to evaluate performance of the trained models of the embedding model 392 and the ranking model 394.

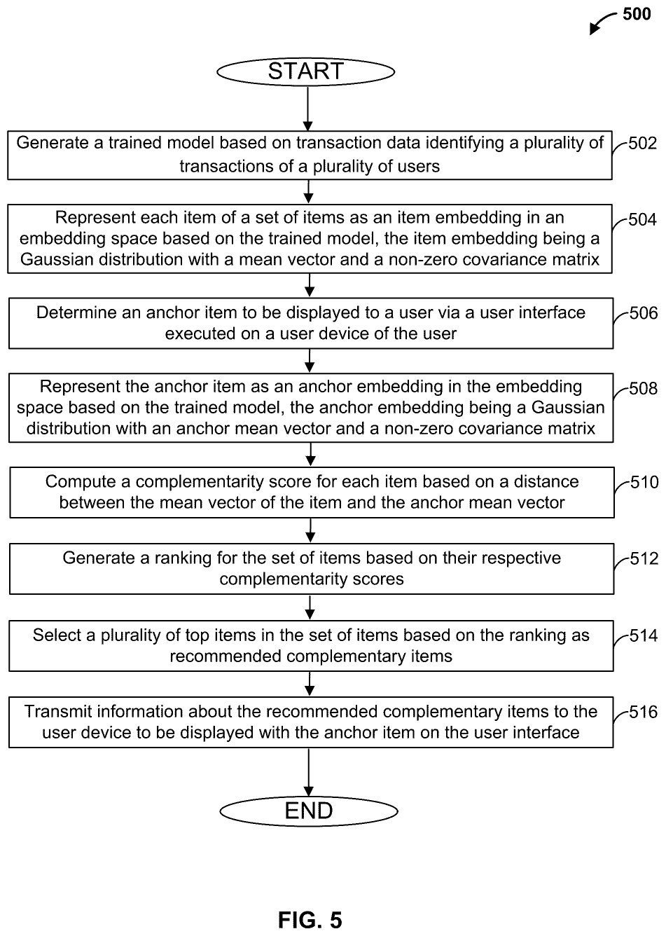

FIG. 5 is a flowchart illustrating a method 500 for complementary item recommendations. In some embodiments, the method 500 can be carried out by a computing device, such as the item recommendation computing device 102 of FIG. 1. Beginning at step 502, a trained model is generated based on transaction data identifying a plurality of transactions of a plurality of users. At step 504, each item of a set of items is represented as an item embedding in an embedding space based on the trained model, the item embedding being a Gaussian distribution with a mean vector and a non-zero covariance matrix.

At step 506, an anchor item is determined to be displayed to a user via a user interface executed on a user device of the user. For example, the anchor item is chosen by the user from a search result or an advertisement shown on the user interface. At step 508, the anchor item is represented as an anchor embedding in the embedding space based on the trained model, the anchor embedding being a Gaussian distribution with an anchor mean vector and a non-zero covariance matrix.

A complementarity score is computed at step 510 for each item based on a distance between the mean vector of the Gaussian distribution for the item and the anchor mean vector of the Gaussian distribution for the anchor item, in the embedding space. For example, a smaller distance means a higher complementarity score and a stronger complementarity. Then a ranking is generated at step 512 for the set of items based on their respective complementarity scores. A plurality of top items is selected at step 514 from the set of items based on the ranking as recommended complementary items. At step 516, information about the recommended complementary items is transmitted to the user device to be displayed with the anchor item on the user interface.

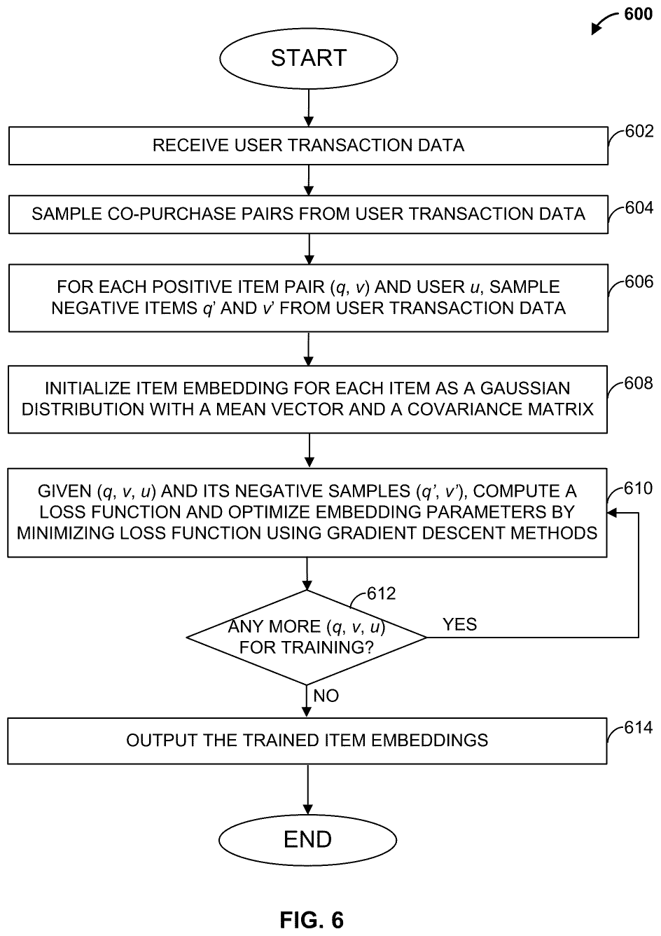

FIG. 6 is a flowchart illustrating an exemplary method 600 that can be carried out by an item recommendation computing device, such as the item recommendation computing device 102 of FIG. 1, in accordance with some embodiments of the present teaching. Beginning at step 602, user transaction data is received. At step 604, co-purchase pairs are sampled from the user transaction data as positive item pairs. At step 606, for each positive item pair (q, v) and user u, negative items q′ and v′ are sampled from the user transaction data. In some embodiments, q and v are different products, while the order of q, v in each pair does not matter.

Item embedding is initialized at step 608 for each item as a Gaussian distribution with a mean vector and a covariance matrix. Given (q, v, u) and its negative samples (q′, v′) at step 610, a loss function is computed to optimize embedding parameters by minimizing the loss function, e.g. using gradient descent methods. At step 612, it is determined whether there is any more (q, v, u) for training. If so, the process goes back to step 610 to process the (q, v, u). If not, the process goes to step 614 to output the trained item embeddings, with optimized embedding parameters. The embedding parameters may include mean vector and variance matrix for each item's Gaussian embedding. In some embodiments, the embedding parameters may also include a dimensionality for each item's Gaussian embedding.

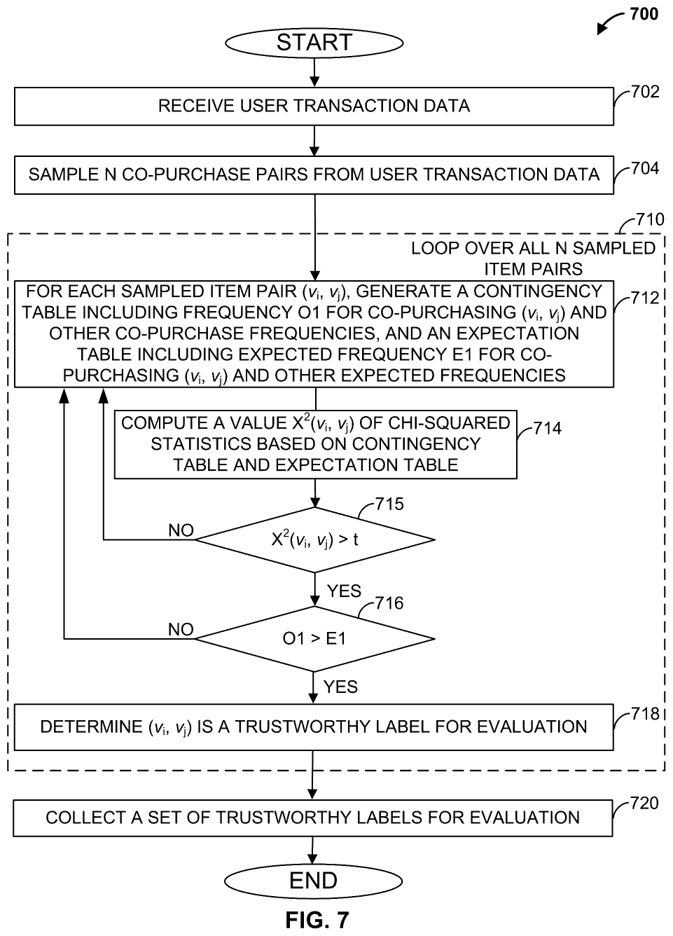

FIG. 7 is a flowchart illustrating another exemplary method 700 that can be carried out by an item recommendation computing device, such as the item recommendation computing device 102 of FIG. 1, in accordance with some embodiments of the present teaching. Beginning at step 702, user transaction data is received. At step 704, N co-purchase pairs are sampled from the user transaction data. Then the process goes to step 710, which includes steps 712 to 718 to loop over all of the N sampled item pairs.

At step 712, for each sampled item pair (vi, vj), a contingency table is generated to include frequency O1 for co-purchasing (vi, vj) and other co-purchase frequencies; and an expectation table is generated to include an expected frequency E1 for co-purchasing (vi, vj) and other expected co-purchase frequencies. A value X²(vi, vj) of Chi-squared statistics is computed at step 714 based on the contingency table and the expectation table. At step 715, it is determined whether the value X²(vi, vj) is larger than a predetermined threshold t. If so, the process goes to step 716; otherwise, the process goes to step 712 to process next sampled item pair. At step 716, it is determined whether the frequency O1 is larger than the expected frequency E1. If so, the process goes to step 718; otherwise, the process goes to step 712 to process next sampled item pair. At step 718, the item pair (vi, vj) is determined to be a trustworthy label for evaluation of the trained recommendation models, e.g. the embedding model 392 and the ranking model 394 as shown in FIG. 3 and FIG. 4.

After looping over all of the N sampled item pairs based on steps 712 to 718, a set of trustworthy labels are collected at step 720 for evaluation of the trained recommendation models, e.g. the embedding model 392 and the ranking model 394 as shown in FIG. 3 and FIG. 4. The trustworthy labels may be stored in a database, e.g. the database 116 as shown in FIG. 1.

In some embodiments, the system defines the co-purchase records from transactions for modeling item-level complementary relationship and generating item representation for recommendations. Let v denote an item from the item set V and b denote a transaction (a set of purchased items) from the transactions set [symbol] where b={v₁, v₂, . . . }. A tuple (vᵢ, vⱼ), vᵢ≠vⱼ, from the same transaction b can be considered as a pair of co-purchased items (i.e., a co-purchase record). To further distinguish the role of co-purchased items during training, inference and evaluation, the first item in an item pair (vᵢ, vⱼ) is treated as the anchor item or query item q; and the second item is treated as the recommendation of q.

Learning the complementary relationship with the co-purchase data as labels could suffer from the label noisy, as co-purchased items are not necessarily complementary items. Without considering the noise in the co-purchase labels, a distance between item embeddings of different items is hardly reflecting the complementary relationship, even though it might be a good approximation for co-purchases.

To address the label noise issue for learning complementary relationship, the system disclosed above models the co-purchase data as a Gaussian distribution, where the mean is the co-purchases from the true complementary, and the variance is the co-purchase from the noise. One can consider each item v∈V as a Gaussian embedding [symbol] (x; μᵥ, Σᵥ), where μᵥ∈ [symbol] ^{d} is the mean vector and Σᵥ∈ [symbol] ^{d×d} is the covariance matrix in the d-dimensional embedding space, which models the variation in the co-purchase behavior of v. Instead of using inner product between vectors of two items to model their complementary relationship from the co-purchase record, the system computes an expected likelihood as the inner product of two Gaussian embeddings to parameterize the Gaussian distribution of complementary relationships. Given an item pair (q, v), the expected likelihood between their Gaussian embeddings is defined in Equation (1), which is the probability density of a Gaussian distribution at zero, [symbol] (0; μ_{q}−μᵥ, Σ_{q}+Σᵥ).

$$\begin{matrix}E ( q , v ) = {\int }_{x ∈ {ℝ}^{d}} 𝒩 ( x ; {μ}_{q} , {\sum }_{q} ) 𝒩 ( x ; {μ}_{v} , {\sum }_{v} ) dx \\ = 𝒩 ( 0 ; {μ}_{q} - {μ}_{v} , {\sum }_{q} + {\sum }_{v} )\end{matrix} \qquad ( 1 )$$

Hence, [symbol] (x; μ_{q}−μᵥ,Σ_{q}+Σᵥ) denotes the Gaussian distribution of the co-purchase data between (q, v), where the mean is the difference between two items' mean vectors in complementary space and the covariance matrix combines the variance of each individual items. The probability density at zero, [symbol] (0; μ_{q}−μᵥ,Σ_{q}+Σᵥ), represents the likelihood of observing a co-purchase record of (q, v) when considering both their complementary relationship (μ_{q}−μᵥ) and variations of purchase behaviors (Σ_{q}+Σᵥ).

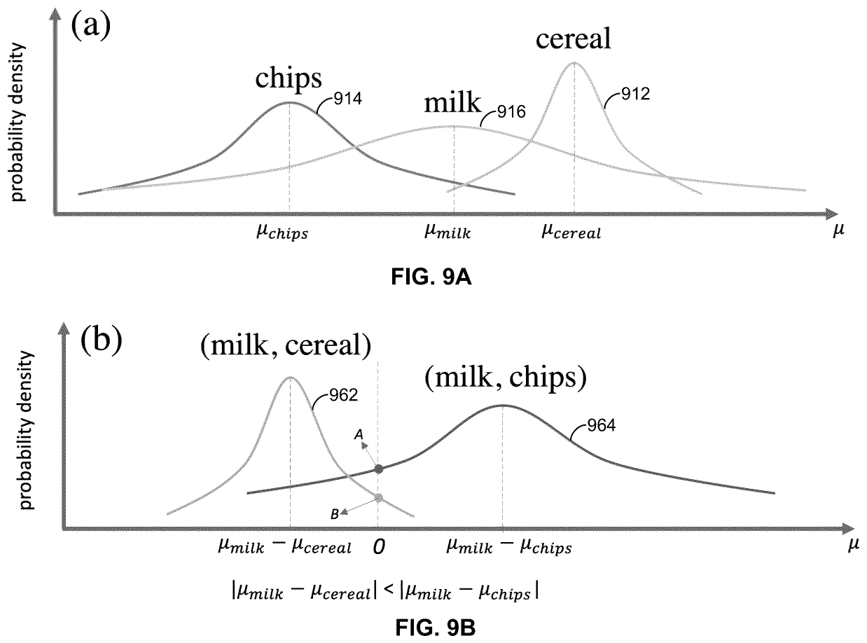

To illustrate the benefit of representing both co-purchase data and items embeddings as Gaussian distributions, one can consider an example from people's daily shopping: milk, cereal and chips, in a one-dimensional embedding space as shown in FIG. 9A and FIG. 9B. In FIG. 9A, milk's Gaussian embedding 916 has the largest variance among three items because it is usually a must-buy for many customers and very likely to be co-purchased with other items without complementary relationships. Cereal's Gaussian embedding 912 has the smallest variance due to its stable co-purchase behavior with milk. The variance of chips' Gaussian embedding 914 is intermediate because it has some stable combinations such as chips dips while users might also buy them individually as a snack before checkout, which makes it variance relatively larger.

FIG. 9B shows the Gaussian distributions of their complementary relationship and highlights the their probability density at zero by the point A for item pair (milk, chips) and the point B for item pair (milk, cereal), when milk serves as the query item. Because of the difference of variances, the Gaussian distribution 962 of the co-purchase for (milk, cereal) shows less variance than the Gaussian distribution 964 of the co-purchase for (milk, chips). Even though the observed co-purchase records between milk and chips might be more than those between milk and cereal (e.g. based on a larger variance of the Gaussian distribution 964 than that of the Gaussian distribution 962), the trained model can still capture the correct order of complementary relationships by comparing |μₘᵢₗₖ−μ_{cereal}| and |μₘᵢₗₖ−μ_{chips}|. For example, FIG. 9B shows a visualization of [symbol] (0; μₘᵢₗₖ−μ_{chips},Σₘᵢₗₖ+Σ_{chips}) (the point A) and [symbol] (0; μₘᵢₗₖ−μ_{cereal},Σₘᵢₗₖ+Σ_{cereal}) (the point B) when milk serves as an query item. While likelihood of observing (milk, chips) could be larger than that of observing (milk, cereal) in the noisy co-purchase records (A>B), the correct complementary relationship between milk and cereal is captured by the distance between μₘᵢₗₖ and μ_{cereal}, Where |μₘᵢₗₖ−μ_{cereal}|<|μₘᵢₗₖ−μ_{chips}|, meaning item pair (milk, cereal) has a stronger complementary relationship that item pair (milk, chips).

A direct fit for co-purchase frequency without considering the variances of item embeddings might result in a different order of complementary relationship. For example, assuming variances of all Gaussian distributions are set to be zero or to be the same (no consideration of variances or noise in the co-purchase data), e.g. same as the variance of the Gaussian distribution 962, then the Gaussian distribution 964 must be moved to the left to be closer to 0 than the Gaussian distribution 962 to fit the co-purchase data by making A>B. Then, a different and wrong conclusion will be drawn, where |μₘᵢₗₖ−μ_{cereal}|>|μₘᵢₗₖ−μ_{chips}|, meaning item pair (milk, cereal) has a weaker complementary relationship that item pair (milk, chips).

In some embodiments, the system can generate the negative sample v′ which is not co-purchased with q, and construct a max-margin loss function with the margin γ in Equation (2):

$${ℒ}_{i t e m} ( q , v , {v}^{′} ) = max ( 0 , γ - log E ( q , v ) + log E ( q , {v}^{′} ) ) where log E ( q , v ) = - \frac{1}{2} log det ( {\sum }_{q} + {\sum }_{v} ) - \frac{d}{2} log ( 2 π ) - \frac{1}{2} {( {μ}_{q} - {μ}_{v} )}^{T} {( {\sum }_{q} + {\sum }_{v} )}^{- 1} ( {μ}_{q} - {μ}_{v} ) .$$

In some embodiments, user information will help improving the learning of item-to-item relationship in a collaborative way by introducing the user embedding to the Item2Vec model. The above mentioned model can be extended easily with user information. Specially, the system can adopt the advantage of modeling the cohesion of each (item, item, user) triplet and modify the Bayesian Personalized Ranking (BPR) loss to model user-item relationship by minimizing the loss functions (3) and (4), where σ(·) is the sigmoid function and q′, v′ represent the negative samples that are not purchased. These loss functions can be combined together with [symbol] ᵢₜₑₘ(q, v, v′) to form a new loss function [symbol] ᵢₜₑₘ(q, v, v′|u)= [symbol] ᵢₜₑₘ(q, v, v′)+ [symbol] _{BPR}(u, q, q′)+ [symbol] _{BPR}(u, v, v′).

[symbol]

_{BPR}(u, q, q′)=1−σ(θᵤ^{T}μ_{q}−θᵤ^{T}μ_{q′}) (3)

[symbol]

_{BPR}(u, v, v′)=1−σ(θᵤ^{T}μᵥ−θᵤ^{T}μ_{v′}) (4)

Depending on whether to consider [symbol] ᵢₜₑₘ(q, v, v′) or [symbol] ᵢₜₑₘ(q, v, v′|u) for a given co-purchase record (q, v), the final objective function [symbol] can be written in Equation (5), where S denotes the sampled records for training and [symbol] ᵢₜₑₘ could be [symbol] ᵢₜₑₘ(q, v, v′) or [symbol] ᵢₜₑₘ(q, v, v′|u). In some embodiments, the system can optimize [symbol] by mini-batch Stochastic Gradient Descent.

[symbol]

=Σ_{(q, v, v′, u)∈S} [symbol] ᵢₜₑₘ (5)

In some embodiments, the system can minimize the final objective function [symbol] in Equation (5), to find an optimal set of {μ, Σ} following Equation (6):

{μ, Σ}= [symbol] [symbol] (6)

where {μ, Σ} represents an optimal set of items' mean vectors and covariance matrices, and {μ′, Σ′}∈ [symbol] represents a set of items' mean vectors and covariance matrics from the entire hypothesis space.

To recommend complementary items, the system can extract the item Gaussian embeddings and treat the mean vector of each item as its representation under complementary relation. In some embodiments, to mitigate the impact of the vector magnitude when computing the distance between mean vectors for ranking and comparison, the system can utilize Item2Vec and Triple2Vec and use the cosine similarity between two items' mean vectors to represent the relevance of the complementary relationship.

Even after addressing the label noise issue in the modeling step by considering the co-purchase data as a Gaussian distribution with item Gaussian embeddings, label noise may still impact the evaluation accuracy as well. As such, the system utilizes a trustworthy evaluation to exam the models with high quality labels generated from an independence test-based method. This evaluation does not require extra information (item description, co-view data, etc.) for creating the high quality labels.

Inspired from the definition of complementary items, the system can treat the purchase of an individual item v as a random variable from a Bernoulli distribution Yᵥ˜Bernoulli(pᵥ), and study the independence between two items' purchase to surface the item pairs which are co-purchased dependently. Pearson's chi-squared test may be suitable for this task, as it can assess whether observations including measures on two variables, expressed in a contingency table, are independent of each other. Given two co-purchased items vᵢ and vⱼ, the system can generate a 2-by-2 contingency table (Table I) for the observations of the purchase events between vᵢ and vⱼ with the one degree of freedom. Let N denote the total number of observed co-purchase records in the evaluation dataset. [symbol] ᵥ_{ᵢ}( [symbol] ᵥ_{ⱼ}) represents the frequency of co-purchases including the item vᵢ (vⱼ) and Oᵢ represents the observed frequency of different purchase events defined in Table I. Typically, O₁ represents the observed co-purchases of (vᵢ, vⱼ). Following the definition of [symbol] ᵥ_{ᵢ} and [symbol] ᵥ_{ⱼ}, the system can compute that: O₂= [symbol] ᵥ_{ⱼ}−O₁, O₃= [symbol] ᵥ_{ᵢ}−O₁ and O₄=N−O₁−O₂−O₃=N− [symbol] ᵥ_{ᵢ}− [symbol] ᵥ_{ⱼ}+O₁.

TABLE I
2-BY-2 CONTINGENCY TABLE OF 4 DIFFERENT PURCHASE
EVENTS BETWEEN νᵢ AND νⱼ.

| | Y_{ν}_{ⱼ} = 1 | Y_{ν}_{ᵢ} = 0 | SUM |
|---|---|---|---|
| Y_{ν}_{ⱼ} = 1 | O₁ = frequency of | O₂ = frequency of | [symbol] _{ν}_{ⱼ} |
| | observed co-purchase | observed co-purchase | |
| | (νᵢ, νⱼ) | of νⱼ with all items\νᵢ | |
| Y_{ν}_{ⱼ} = 0 | O₃ = frequency of | O₄ = frequency of | N − [symbol] _{ν}_{ⱼ} |
| | observed co-purchase | observed co-purchase | |
| | of νᵢ with all items\νⱼ | w/o (νᵢ, νⱼ) | |
| SUM | [symbol] _{ν}_{ⱼ} | N − [symbol] _{ν}_{ᵢ} | N |

Without any knowledge of item complementary relationships, one can assume that each pair of co-purchased items, vᵢ and vᵢ, are independent (the null hypothesis in the test H₀). The alternative hypothesis Hₐ is that they are purchased dependently. The system can compute the estimated frequency for each purchase event Eᵢ based on the independence assumption by Table II. Following the Chi-squared test, the system can compute the value of the Chi-squared statistics

$${𝒳}^{2} = {\sum }_{i = 1}^{4} \frac{{( {O}_{i -} {E}_{i} )}^{2}}{{E}_{i}}$$

which is used to determine the significance (p-value) by comparing to a Chi-squared distribution with one degree of freedom. Item pairs which pass the Chi-squared test mean that their co-purchase are dependent.

TABLE II
EXPECTED VALUE OF 4 DIFFERENT PURCHASE
EVENTS BETWEEN υᵢ AND υⱼ.

| | Y_{υ}_{ᵢ} = 1 | Y_{υ}_{ᵢ} = 0 |
|---|---|---|
| Y_{υ}_{ⱼ} = 1 | ${E}_{1} = \frac{{ℱ}_{{υ}_{i}} \cdot {ℱ}_{{υ}_{j}}}{N}$ | ${E}_{2} = \frac{( N - {ℱ}_{{υ}_{i}} ) \cdot {ℱ}_{{υ}_{j}}}{N}$ |
| Y_{υ}_{ⱼ} = 0 | ${E}_{3} = \frac{{ℱ}_{{υ}_{i}} \cdot ( N - {ℱ}_{{υ}_{j}} )}{N}$ | ${E}_{4} = \frac{( N - {ℱ}_{{υ}_{i}} ) \cdot ( N - {ℱ}_{{υ}_{j}} )}{N}$ |

In addition, the system can determine if the dependency of a co-purchased item pair is positive or negative. To achieve this, the observed co-purchase frequency of an item pair should be larger than the expected frequency under independence assumption, O₁>E₁, if a co-purchased item pair has a positive dependency. With a predefined p-value for the statistic significance, the system can create the high quality co-purchase labels for evaluations. The item pairs which pass the Chi-squared test and O₁>E₁ can be called the positively-dependent item pairs; and the item pairs which pass the Chi-squared test and O₁<=E₁ can be called the negatively-dependent item pairs. An algorithm of generating the trustworthy labels for evaluation is summarized as Algorithm 1.

```
Algorithm 1 Trustworthy Label Generation for Evaluation
Require: a transaction set [symbol] , an empty hashtable Ψ, χ²
  threshold t_{χ}_{²} for a p-value;
Ensure:
  1: for each transaction b in [symbol]  do
  2:  sample co-purchase item pairs (υᵢ, υⱼ) from each trans-
      action b ∈ [symbol] , υᵢ ≠ υⱼ;
  3:  compute the frequency of purchasing (υᵢ, υⱼ) together
      and store the frequency in Ψ, i.e., Ψ [(υᵢ, υⱼ)] represents
      the co-purchase frequency of (υᵢ, υⱼ);
  4: end for
  5: set N = Σ_{(υ}_{ᵢ}_{, υ}_{ⱼ}₎ Ψ [(υᵢ, υⱼ)];
  6: set [symbol] _{υ}_{ᵢ} = Σ_{(υ}_{ₖ}_{, υ}_{ⱼ}_{), υ}_{ₖ}_{= υi} Ψ [(υₖ, υⱼ)];
  7: set [symbol] _{υ}_{ⱼ} = Σ _{(υ}_{ᵢ}_{, υ}_{ₖ}_{), υ}_{ₖ}_{= υ}_{ⱼ} Ψ [(υᵢ, υₖ)];
  8: for each (υᵢ, υⱼ) stored in Ψ do
  9:  compute the 2-by-2 contingency table by Ψ [(υᵢ, υⱼ)].
      N, [symbol] _{υ}_{ᵢ}, and [symbol] _{υ}_{ⱼ} based on Table I;
10:  compute the table of expected value based on Table II;
11:   $compute {𝒳}_{( {υ}_{i} , {υ}_{j} )}^{2} = {\sum }_{i = 1}^{4} \frac{{( {O}_{i} - {E}_{i} )}^{2}}{{E}_{i}}$
12: if χ_{(υ}_{ᵢ}_{, υ}_{ⱼ})² > t_{χ}_{²} and O₁ > E₁ then
13:  mark (υᵢ, υⱼ) as a qualified co-purchase label for
        evaluation
14:  end if
15: end for
```

In some embodiments, the trained model NEAT is compared with other baselines using real-world datasets. In one example, one can consider a publicly available dataset of raw transactions, called INS. The date of each order in this dateset is not provided but the sequence of transactions by each user is available. Items in each transaction are sorted by their purchase orders and the item-types are also provided by the aisles. The INS dataset has 134 aisles from 21 departments and 3.3 million transactions, which is small compared with the real-world applications with more item-types and larger volume of transactions. The system can use the default train (INS-T) and test (INS-E) split provided by INS dataset. In another example, to further study the model performance, one can collect a proprietary dataset (WMT) with a larger scale from Walmart e-Commerce platform (www.walmart.com) following the same format of Instacart, where the sequence order of transactions are kept and the order of purchases in the same sequence is also preserved. For WMT dataset, the system can randomly sample 15.2 million transactions from the past 6-month history data and keep the latest 1.2 million transactions as the test dataset (WMT-E). The rest of 14 million transactions are used for training (WMT-T). Similar to INS dataset, the system can collect the item categories based on the taxonomy of Walmart platform. Co-purchase records are created from INS and WMT dataset respectively to serve model training and label generation for evaluation. Table III summarizes the statistics of the INS and WMT datasets.

TABLE III
DATA DESCRIPTION OF WMT AND INS DATASET

| | INS-T | INS-E | WMT-T | | WMT-E |
|---|---|---|---|---|---|
| # Transactions | 3,214,874 | 131,209 | ~14 | m | ~1.2 m |
| # Items | 49,677 | — | ~0.1 | m | — |
| # Categories/Aisles | 134 | — | ~850 | | — |
| # Users | 206,209 | 131,209 | ~0.7 | m | ~0.4 m |

The system can collect all the co-purchase records for training from the training set including transaction data, as discussed before. To improve the quality of labels for model training, one can remove labels selected in the previous steps where two items are from the same aisles (for INS dataset) or the same category (for WMT dataset) to remove similar items. For evaluation, the system can create the trustworthy labels as discussed before under different p-value={0.05,0.01,0.001}. Experiments are conducted on these unique labels for evaluation. Although these labels are with high quality, it is not practical to be used for training purpose, due to the limited coverage in item space. Table IV summarizes the number of unique labels of the INS and WMT datasets.

TABLE IV
NUMBER OF LABELS IN INS-E AND WMT-E

| | p-value = 0.05 | p-value = 0.01 | p-value = 0.001 |
|---|---|---|---|
| INS-E | 7,961 | 6,077 | 4,752 |
| WMT-E | 78,719 | 53,119 | 36,251 |

To evaluate the effectiveness of applying Gaussian distribution on co-purchase data and item embeddings, one can compare NEAT with the following baselines: (1) Collaborative Filtering (CF): an item recommendation model which factorizes the user-item; (2) Bayesian Personalized Ranking (BPRMF): an item recommendation model which factorizes the user-item implicit feedback from raw transactions by approximately optimizing the AUC ranking metric; (3) Item2Vec: a model that learns vector representations of items via SGNS and optimizes the similarity between item vectors for co-purchase data; (4) Triple2Vec: a model that learns vector representations of item and user, and considers the triplet interaction between a user and her/his co-purchased item pair for complementarity. In addition, one can also consider two popularity-based baselines: Popular Item (Pop) and Popular Co-purchase (PopCo). In Pop, the complementary item recommendations for the query item are the most popular items globally. In PopCo, the query item's popular co-purchased items are taken as the complementary item recommendations.

Depending on whether incorporating the user-item level collaborative learning into the model, there are two variants of the disclosed recommendation model: NEAT, which is trained by optimizing [symbol] with [symbol] ᵢₜₑₘ= [symbol] ᵢₜₑₘ(q, v, v′) to model the item-level complementary co-purchase signals; and NEAT+bpr, which is trained by optimizing [symbol] with [symbol] ᵢₜₑₘ= [symbol] ᵢₜₑₘ(q, v, v′|u), to further model the user-item level collaborative learning for complementary signals in addition to the item-level complementary signals.

For simplicity, one can set the covariance matrix in the NEAT model to be spherical. In some embodiments, the margin γ in Equation (2) is set to be 0.5 for the computation of Hit-Rate (HR) and Normalized Discounted Cumulative Gain (NDCG). For example, the system can apply the following settings for all models in the experiments, unless it is specified: the dimension of the item embeddings are set to be 100, the window size for sampling co-purchased items is set to be 5, and all models are trained for 5 epochs. For Item2Vec, Triple2Vec and the disclosed model, the batch size is 128, with the initial learning rate of 0.05 and the mini-batch Stochastic Gradient Descent (SGD) optimizer. The number of negative sample may be set to 5 during training.

To present the study of the trustworthy label generation method and show its effectiveness, there are three major concerns of data labeling: coverage, consistency and accuracy.

A good data labeling method should have enough coverage on the representative patterns of the dataset. For e-commerce, the label generation should show a good coverage of different item categories and departments instead of being biased to few item categories. To illustrate the coverage of the disclosed label generation method, the system can focus on the department level without the loss of generality and readability and compute the distribution of labels over different departments for the INS-E dataset in Table V. Compared with the distribution of total co-purchase records from the INS-E dataset, these labels show similar distributions over all departments. The Pets department is not covered by these labels, because most of the raw co-purchase records with pet-related items also includes non-pet-related items like grocery in the INS-E dataset, which are not complementary. The label distribution over departments indicates that the disclosed method is not biased to a certain department and covers complementary signals of item purchase behaviors under various departments.

TABLE V
DISTRIBUTION OF LABELS OVER
DEPARTMENTS OF INS-E DATASET

| Department | Total | p = 0.05 | p = 0.01 | p = 0.001 |
|---|---|---|---|---|
| alcohol | 0.370% | 0.339% | 0.411% | 0.505% |
| babies | 1.451% | 0.364% | 0.378% | 0.337% |
| bakery | 4.462% | 4.459% | 4.048% | 3.788% |
| beverage | 9.437% | 8.504% | 8.672% | 9.007% |
| breakfast | 2.796% | 1.306% | 1.349% | 1.410% |
| bulk | 0.100% | 0.100% | 0.115% | 0.126% |
| canned | 4.001% | 2.927% | 2.781% | 2.399% |
| goods | | | | |
| dairy | 17.101% | 23.678% | 22.100% | 20.623% |
| eggs | | | | |
| deli | 3.594% | 2.487% | 2.403% | 2.273% |
| dry goods | 3.559% | 1.859% | 1.678% | 1.599% |
| pasta | | | | |
| frozen | 8.715% | 3.944% | 3.966% | 4.167% |
| household | 3.016% | 0.867% | 0.889% | 0.989% |
| international | 1.138% | 0.603% | 0.675% | 0.526% |
| meat seafood | 2.474% | 2.613% | 2.271% | 2.041% |
| missing | 0.759% | 1.017% | 1.1529% | 1.305% |
| other | 0.168% | 0.038% | 0.049% | 0.042% |
| pantry | 6.720% | 2.927% | 2.946% | 2.736% |
| personal | 1.772% | 0.113% | 0.115% | 0.147% |
| care | | | | |
| pets | 0.484% | 0.000% | 0.000% | 0.000% |
| produce | 17.369% | 30.511% | 31.019% | 31.587% |
| snacks | 10.512% | 11.343% | 12.983% | 14.394% |
| SUM | 6249077 | 7961 | 6077 | 4752 |

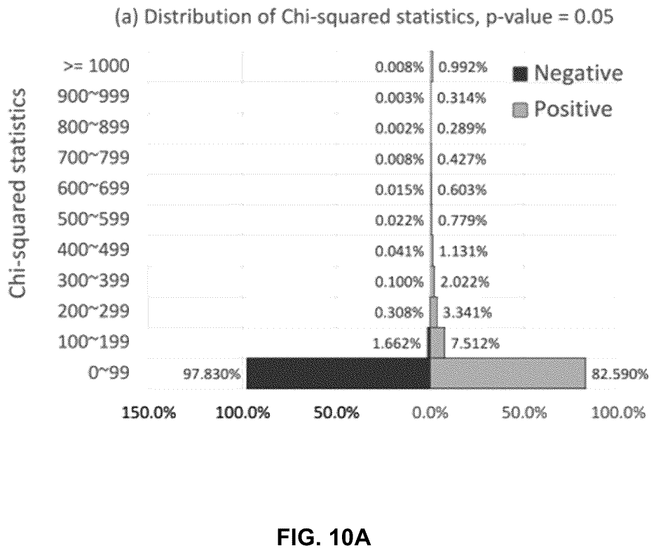

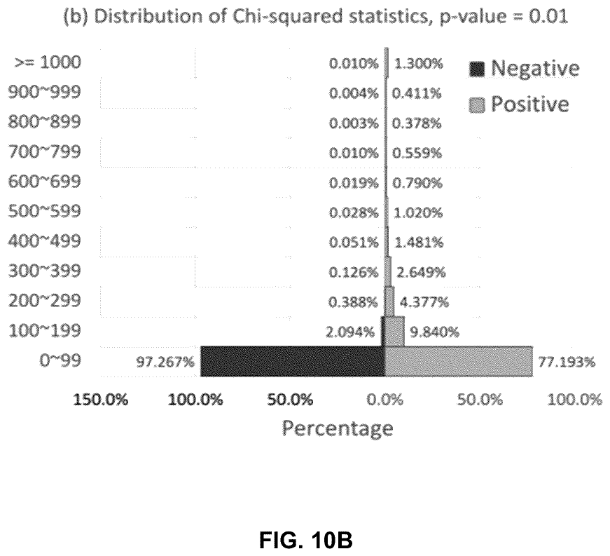

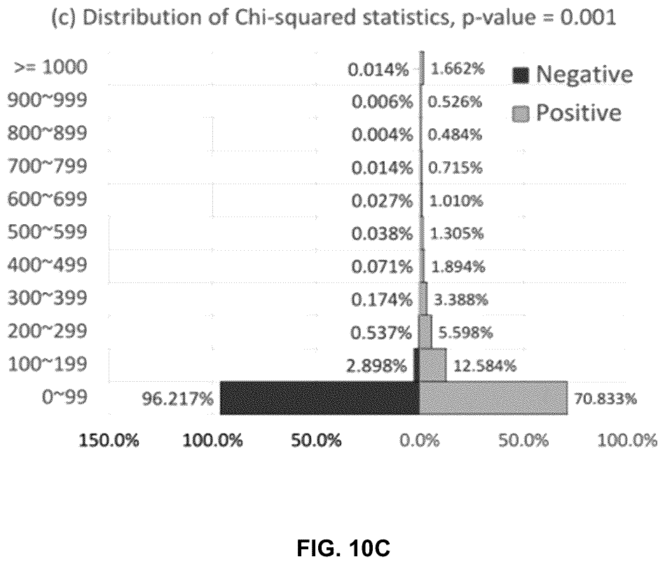

To keep consistency of a label generation method, the percentage of complementary labels should increase as the p-value decreases. To show such a consistency, one can plot the distribution of χ² statistics for each item pair which passes the test for a given p-value for both positively dependent item pairs (O₁>E₁) and negatively dependent item pairs (O₁<=E₁), as shown in FIG. 10A to FIG. 10C. FIG. 10A, FIG. 10B and FIG. 10C show distributions of χ² of both positively dependent labels and negatively dependent labels with p-value=0.05, 0.01 and 0.001, respectively. While most of the labels (both negative and positive) are with χ² statistics between 0 and 99, the percentage of positively dependent item pairs with higher χ² statistics has a larger lift as the p-value decreases compared with the negatively dependent item pairs. Because the system uses the positively dependent item pairs as the labels for evaluation, this consistency between the increase of more complementary labels and the decrease of p-value indicates that raising the significance level by p-value can further concentrate the co-purchase labels with positively dependence (complementary relationships).

A case study of the positively dependent item pairs (the trustworthy labels) and the negatively dependent item pairs is provided in Table VI and VII to show that the disclosed model can provide more accurate labels for evaluation. In some embodiments, the chi-squared statistics χ² should be not smaller than 10.83 for p-value=0.001. Both positive and negative item pairs show large enough chi-squared statistics. While the positive labels are showing clear complementary relationships, e.g., syrup for waffle, hot dog buns for hot dog, and kitchen bag for laundry-related items for household, the negative labels reflect the noise in the co-purchase records even though they pass the Chi-squared test. Most of the co-purchased items in the negative labels are fruits like Banana, which are the popular items in the INS dataset. See examples of top-20 popular items in the INS dataset in Table VIII. The comparison between the positive labels and the negative labels indicates that the disclosed label generation method can surface more complementary labels while suppressing the noise in the co-purchase records.

TABLE VI
POSITIVELY-DEPENDENT ITEM PAIR,
INS DATASET WITH P-VALUE = 0.001

| Query Item | Co-purchased Item | χ² |
|---|---|---|
| Beef Hot Dogs | Classic Hot Dog Buns | 5084.536 |
| Everything Bagels | Whipped Cream Cheese | 85.501 |
| Thin & Light Tortilla Chips | Medium Salsa Roja | 239.958 |
| Eggo Homestyle Waffles | Original Syrup | 170.825 |
| Cherrios Honey Nut (cereal) | Reduced Fat 2% Milk | 62.804 |
| Green Curry Paste | Organic Coconut Milk | 51.005 |
| Plain Mini Bagels | Philadelphia Cream | 33.513 |
| | Cheese Spread | |
| Stand 'n Stuff Taco Shells | Original Taco Seasoning Mix | 20.774 |
| Snack Bags (food storage) | Sandwich Bags (food storage) | 106.078 |
| Fabric Softener Dryer Sheet | Tall Kitchen Bag | 1414.015 |
| | With Febreze Odor Shield | |

TABLE VII
NEGATIVELY-DEPENDENT ITEM PAIR,
INS DATASET WITH P-VALUE = 0.001

| Query Item | Co-purchased Item | χ² |
|---|---|---|
| Organic Sea Salt | Banana | 108.817 |
| Roasted Seaweed Snacks | | |
| Free & Clear Unscented Baby Wipes | Large Lemon | 61.033 |
| Naturals Savory Turkey | Strawberries | 18.558 |
| Breakfast Sausage | | |
| Gluten Free Whole Grain Bread | Large Lemon | 52.104 |
| Eggo Homestyle Waffles | Organic Cucumber | 42.681 |
| Naturals Chicken Nuggets | Organic Avocado | 60.222 |
| Cheerios Honey Nut (cereal) | Jalapeno Peppers | 33.853 |
| Everything Bagels | Organic Strawberries | 35.512 |
| Taco Seasoning | Organic Raspberries | 53.735 |
| Laundry Detergent Free & Clear | Banana | 16.293 |

The system can use HitRate (HR@K) and NDCG@K of evaluation as evaluation metrics. Given the query item q, the system can consider the top-K recommendations R_{q} has a hit on the test co-purchase record (q, v) if v∈R_{q}:

$$HR @ K = \{ \begin{matrix}1 , & if v ∈ {R}_{q} \\ 0 , & otherwise\end{matrix} .$$

For NDCG@K, the system can consider the binary relevance score and define it as

$$NDCG @ K = \{ \begin{matrix}\frac{1}{{log}_{2} ( 1 + {rank}_{v} )} , \\ 0 ,\end{matrix}$$

ifv∈R_{q} otherwise

TABLE VIII
TOP-20 GLOBALLY POPULAR ITEMS, INS DATASET

| Rank | Item |
|---|---|
| 1 | Banana |
| 2 | Bag of Organic Bananas |
| 3 | Organic Strawberries |
| 4 | Organic Baby Spinach |
| 5 | Organic Hass Avocado |
| 6 | Organic Avocado |
| 7 | Large Lemon |
| 8 | Strawberries |
| 9 | Limes |
| 10 | Organic Whole Milk |
| 11 | Organic Raspberries |
| 12 | Organic Yellow Onion |
| 13 | Organic Garlic |
| 14 | Organic Zucchini |
| 15 | Organic Blueberries |
| 16 | Cucumber Kirby |
| 17 | Organic Fuji Apple |
| 18 | Organic Lemon |
| 19 | Apple Honeycrisp Organic |
| 20 | Organic Grape Tomatoes |

To evaluate the ability to surface complementary recommendations from the noisy co-purchase data, the system can first generate the recall set by taking the top-K most co-purchased items for the query item in the training data, rather than a sampled item set in which each ground truth item in the test set is paired with a few (e.g., 100) randomly sampled negative items. The system can report the average score over the co-purchase records for HR@K and NDCG@K, K={1,3,5,10,20}.

TABLE IX
INS LABELS, P-VALUE = 0.05

| | HR@1 | NDCG@1 | HR@3 | NDCG@3 | HR@5 | NDCG@5 | HR@10 | NDCG@10 | HR@20 | NDCG@20 |
|---|---|---|---|---|---|---|---|---|---|---|
| Pop | 0.0000 | 0.0000 | 0.0000 | 0.0000 | 0.0001 | 0.0001 | 0.0014 | 0.0005 | 0.0035 | 0.0010 |
| PopCo | 0.0122 | 0.0122 | 0.0437 | 0.0303 | 0.0734 | 0.0425 | 0.1334 | 0.0617 | 0.2168 | 0.0826 |
| CF | 0.0087 | 0.0087 | 0.0245 | 0.0176 | 0.0396 | 0.0238 | 0.0765 | 0.0355 | 0.1516 | 0.0543 |
| BPRMF | 0.0067 | 0.0067 | 0.0225 | 0.0155 | 0.0368 | 0.0214 | 0.0720 | 0.0326 | 0.1467 | 0.0512 |
| Item2Vec | 0.0196 | 0.0196 | 0.0484 | 0.0360 | 0.0746 | 0.0468 | 0.1271 | 0.0636 | 0.2231 | 0.0876 |
| Triple2Vec | 0.0221 | 0.0221 | 0.0541 | 0.0403 | 0.0813 | 0.0514 | 0.1325 | 0.0678 | 0.2110 | 0.0874 |
| NEAT | 0.0252 | 0.0252 | 0.0633 | 0.0468 | 0.0970 | 0.0606 | 0.1574 | 0.0798 | 0.2593 | 0.1054 |
| NEAT + bpr | 0.0249 | 0.0249 | 0.0628 | 0.0464 | 0.0927 | 0.0586 | 0.1628 | 0.0811 | 0.2591 | 0.1053 |

TABLE X
INS LABELS, P-VALUE = 0.01

| | HR@1 | NDCG@1 | HR@3 | NDCG@3 | HR@5 | NDCG@5 | HR@10 | NDCG@10 | HR@20 | NDCG@20 |
|---|---|---|---|---|---|---|---|---|---|---|
| Pop | 0.0000 | 0.0000 | 0.0000 | 0.0000 | 0.0000 | 0.0000 | 0.0015 | 0.0005 | 0.0023 | 0.0007 |
| PopCo | 0.0155 | 0.0155 | 0.0541 | 0.0378 | 0.0000 | 0.0526 | 0.1593 | 0.0747 | 0.2587 | 0.0996 |
| CF | 0.0100 | 0.0100 | 0.0276 | 0.0200 | 0.0443 | 0.0268 | 0.0849 | 0.0397 | 0.1711 | 0.0612 |
| BPRMF | 0.0076 | 0.0076 | 0.0262 | 0.0180 | 0.0415 | 0.0243 | 0.0819 | 0.0372 | 0.1654 | 0.0580 |
| Item2Vec | 0.0230 | 0.0230 | 0.0559 | 0.0418 | 0.0859 | 0.0541 | 0.1450 | 0.0729 | 0.2549 | 0.1004 |
| Triple2Vec | 0.0253 | 0.0253 | 0.0635 | 0.0472 | 0.0931 | 0.0593 | 0.1502 | 0.0775 | 0.2391 | 0.0998 |
| NEAT | 0.0293 | 0.0293 | 0.0734 | 0.0543 | 0.1121 | 0.0701 | 0.1833 | 0.0928 | 0.2998 | 0.1221 |
| NEAT + bpr | 0.0286 | 0.0286 | 0.0732 | 0.0540 | 0.1084 | 0.0684 | 0.1899 | 0.0945 | 0.3011 | 0.1224 |

TABLE XI
INS LABELS, P-VALUE = 0.001

| | HR@1 | NDCG@1 | HR@3 | NDCG@3 | HR@5 | NDCG@5 | HR@10 | NDCG@10 | HR@20 | NDCG@20 |
|---|---|---|---|---|---|---|---|---|---|---|
| Pop | 0.0000 | 0.0000 | 0.0000 | 0.0000 | 0.0000 | 0.0000 | 0.0013 | 0.0004 | 0.0023 | 0.0007 |
| PopCo | 0.0189 | 0.0189 | 0.0640 | 0.0450 | 0.1048 | 0.0618 | 0.1833 | 0.0869 | 0.2963 | 0.1152 |
| CF | 0.0112 | 0.0112 | 0.0316 | 0.0227 | 0.0499 | 0.0302 | 0.0943 | 0.0443 | 0.1896 | 0.0681 |
| BPRMF | 0.0082 | 0.0082 | 0.0286 | 0.0197 | 0.0452 | 0.0266 | 0.0922 | 0.0415 | 0.1841 | 0.0645 |
| Item2Vec | 0.0265 | 0.0265 | 0.0623 | 0.0468 | 0.0962 | 0.0607 | 0.1616 | 0.0816 | 0.2870 | 0.1129 |
| Triple2Vec | 0.0276 | 0.0276 | 0.0711 | 0.0525 | 0.1040 | 0.0659 | 0.1681 | 0.0864 | 0.2668 | 0.1111 |
| NEAT | 0.0335 | 0.0335 | 0.0835 | 0.0619 | 0.1273 | 0.0798 | 0.2075 | 0.1054 | 0 3403 | 0.1388 |
| NEAT + bpr | 0.0341 | 0.0341 | 0.0823 | 0.0613 | 0.1227 | 0.0778 | 0.2163 | 0.1078 | 0.3424 | 0.1395 |

Tables IX-XIV summarize the results of HR@K and NDCG@K for INS dataset (in Tables IX-XI) and WMT dataset (in Tables XII-XIV). The best performance for each metric is highlighted in bold. Pop shows zero HR@K and NDCG@K when K is small. As aforementioned, popular items are involved in many co-purchase records which are not motivated by complementary relationships. After removing irrelevant co-purchase records from the dataset by the trustworthy label generation, Pop is less likely to hit a complementary co-purchase. Popco still achieves reasonable performance on all metrics because it captures the noisy item-to-item complementary relationship via ranking the co-purchased items by their co-purchase frequency with the query item. Item2Vec and Triple2Vec outperform the frequency-based baselines due to the advantage of item vector representation. The disclosed models (NEAT, NEAT+bpr) further improve the performance on both HR and NDCG compared with frequency-based baselines and the vector-based baselines. The results indicate the advantage of modeling the label noise in the co-purchase distribution.

TABLE XII
WMT LABELS, P-VALUE = 0.05

| | HR@1 | NDCG@1 | HR@3 | NDCG@3 | HR@5 | NDCG@5 | HR@10 | NDCG@10 | HR@20 | NDCG@20 |
|---|---|---|---|---|---|---|---|---|---|---|
| Pop | 0.0000 | 0.0000 | 0.0000 | 0.0000 | 0.0008 | 0.0000 | 0.0002 | 0.0001 | 0.0014 | 0.0004 |
| PopCo | 0.0069 | 0.0069 | 0.0207 | 0.0148 | 0.0310 | 0.0190 | 0.0506 | 0.0253 | 0.0803 | 0.0328 |
| CF | 0.0033 | 0.0033 | 0.0076 | 0.0058 | 0.0105 | 0.0070 | 0.0193 | 0.0098 | 0.0451 | 0.0162 |
| BPRMF | 0.0042 | 0.0042 | 0.0108 | 0.0080 | 0.0164 | 0.0103 | 0.0276 | 0.0139 | 0.0505 | 0.0196 |
| Item2Vec | 0.0082 | 0.0082 | 0.0200 | 0.0149 | 0.0298 | 0.0189 | 0.0504 | 0.0256 | 0.0818 | 0.0335 |
| Triple2Vec | 0.0087 | 0.0087 | 0.0210 | 0.0158 | 0.0294 | 0.0192 | 0.0438 | 0.0239 | 0.0615 | 0.0283 |
| NEAT | 0.0120 | 0.0120 | 0.0292 | 0.0219 | 0.0437 | 0.0278 | 0.0715 | 0.0367 | 0.1065 | 0.0455 |
| NEAT + bpr | 0.0121 | 0.0121 | 0.0298 | 0.0221 | 0.0437 | 0.0278 | 0.0717 | 0.0368 | 0.1074 | 0.0459 |

TABLE XII
WMT LABELS, P-VALUE = 0.01

| | HR@1 | NDCG@1 | HR@3 | NDCG@3 | HR@5 | NDCG@5 | HR@10 | NDCG@10 | HR@20 | NDCG@20 |
|---|---|---|---|---|---|---|---|---|---|---|
| Pop | 0.0000 | 0.0000 | 0.0000 | 0.0000 | 0.0000 | 0.0000 | 0.0001 | 0.0000 | 0.0013 | 0.0003 |
| PopCo | 0.0099 | 0.0099 | 0.0291 | 0.0208 | 0.0432 | 0.0266 | 0.0695 | 0.0351 | 0.1080 | 0.0448 |
| CF | 0.0042 | 0.0042 | 0.0098 | 0.0074 | 0.0134 | 0.0089 | 0.0244 | 0.0124 | 0.0574 | 0.0206 |
| BPRMF | 0.0055 | 0.0055 | 0.0141 | 0.0104 | 0.0212 | 0.0133 | 0.0359 | 0.0180 | 0.0648 | 0.0252 |
| Item2Vec | 0.0110 | 0.0110 | 0.0261 | 0.0196 | 0.0388 | 0.0248 | 0.0649 | 0.0332 | 0.1059 | 0.0435 |
| Triple2Vec | 0.0117 | 0.0117 | 0.0273 | 0.0207 | 0.0379 | 0.0250 | 0.0563 | 0.0310 | 0.0786 | 0.0366 |
| NEAT | 0.0165 | 0.0165 | 0.0393 | 0.0295 | 0.0583 | 0.0373 | 0.0945 | 0.0490 | 0.1393 | 0.0603 |
| NEAT + bpr | 0.0165 | 0.0165 | 0.0401 | 0.0299 | 0.0582 | 0.0373 | 0.0944 | 0.0490 | 0.1402 | 0.0606 |

TABLE XIV
WMT LABELS, P-VALUE = 0.001

| | HR@1 | NDCG@1 | HR@3 | NDCG@3 | HR@5 | NDCG@5 | HR@10 | NDCG@10 | HR@20 | NDCG@20 |
|---|---|---|---|---|---|---|---|---|---|---|
| Pop | 0.0000 | 0.0000 | 0.0000 | 0.0000 | 0.0000 | 0.0000 | 0.0001 | 0.0000 | 0.0012 | 0.0003 |
| PopCo | 0.0140 | 0.0140 | 0.0407 | 0.0293 | 0.0599 | 0.0371 | 0.0948 | 0.0484 | 0.1437 | 0.0607 |
| CF | 0.0055 | 0.0055 | 0.0129 | 0.0097 | 0.0173 | 0.0115 | 0.0313 | 0.0160 | 0.0730 | 0.0263 |
| BPRMF | 0.0069 | 0.0069 | 0.0177 | 0.0130 | 0.0271 | 0.0168 | 0.0461 | 0.0229 | 0.0831 | 0.0322 |
| Item2Vec | 0.0145 | 0.0145 | 0.0342 | 0.0257 | 0.0504 | 0.0324 | 0.0837 | 0.0431 | 0.1365 | 0.0563 |
| Triple2Vec | 0.0156 | 0.0156 | 0.0356 | 0.0271 | 0.0491 | 0.0327 | 0.0725 | 0.0402 | 0.1010 | 0.0474 |
| NEAT | 0.0226 | 0.0226 | 0.0524 | 0.0396 | 0.0771 | 0.0498 | 0.1237 | 0.0648 | 0.1806 | 0.0792 |
| NEAT + bpr | 0.0223 | 0.0223 | 0.0532 | 0.0399 | 0.0771 | 0.0497 | 0.1241 | 0.0649 | 0.1815 | 0.0794 |

The disclosed model can be extended with user embeddings to model the complementary relationship from the user-item-level co-purchase data. To study the extensibility of the disclosed model and the influence of involving user embeddings, HR@K and NDCG@K are computed for NEAT and NEAT+bpr, K={1,3,5,10,20}. The results are summarized in Tables IX-XIV. One can see that both NEAT and NEAT+bpr perform similarly but NEAT+bpr outperforms NEAT in most cases when: (1) K becomes larger or (2) number of items increases from INS dataset to WMT dataset. This indicates that including user-item-level signals improves the model performance especially when the number of items is large.

One can also conduct experiments on NEAT with different margins γ={0.1,0.2,0.5,1.0,2.0} on the three label sets of INS dataset and WMT dataset respectively, to report HR@K and NDCG@K for evaluation with K={5,10,20}. In some embodiments, the results indicate that the disclosed model is in favor of a larger margin.

To test whether the Gaussian embedding of items could capture the variation of items in their co-purchase, one can focus on three items, Whole Milk, Cereal and Organic Tortilla Chips in INS dataset, and study the relationship between item Gaussian embeddings and complementary relationships when Whole Milk becomes the query item. On one hand, the cosine similarity of μ_{WholeMilk} and μ_{Cereal} is larger then that of μ_{WholeMilk} and μ_{OrganicTortillaChips}, which aligns with the expectation of stronger complementary relationship between Whole Milk and Cereal. On the other hand, the query item Whole Milk which has higher popularity than Cereal and Organic Tortilla Chips in INS dataset also shows higher variation (indicated by the determinant of the spherical covariance matrix). In particular, the det(Σ_{WholeMilk}) is 30 times larger than det(Σ_{Cereal}) and is 547 times larger than det(Σ_{OrganicTortillaChips}). This also aligns with the expectation of their variation since Whole milk (35633 purchases) is more popular than Cereal (12184 purchases) and Organic Tortilla Chips (13776 purchases) in INS dataset and hence more likely to form irrelevant co-purchases.

The present teaching discloses a system using a label noise-resistant complementary item recommendation model to address the label noise issue for complementary item recommendation when the co-purchase data are used as labels. The system learns the item representations as Gaussian embeddings, and assumes the co-purchase data as a Gaussian distribution, where the mean is the co-purchases from the true complementary relation, and the variance is the co-purchases from the noise. In addition, the system uses a trustworthy label generation method for model evaluation to alleviate the impact of noisy labels in evaluation process. Extensive experiments are conducted on two real-world datasets to show the effectiveness of the disclosed method over other methods.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon;
at least one processor operatively coupled to the non-transitory memory, and configured to read the instructions to:
generate a trained model based on transaction data identifying a plurality of transactions of a plurality of users,
represent each item of a set of items as an item embedding in an embedding space based on the trained model, wherein the item embedding is a Gaussian distribution with a mean vector and a non-zero covariance matrix,
determine an anchor item to be displayed to a user via a user interface executed on a user device of the user,
represent the anchor item as an anchor embedding in the embedding space based on the trained model, wherein the anchor embedding is a Gaussian distribution with an anchor mean vector and an anchor non-zero covariance matrix,
compute a complementarity score for each item of the set of items, based on a distance between the mean vector of the item and the anchor mean vector,
generate a ranking for the set of items based on their respective complementarity scores,
select a plurality of top items in the set of items based on the ranking as recommended complementary items, and
transmit information about the recommended complementary items to the user device to be displayed with the anchor item on the user interface.

2. The system of claim 1, wherein the trained model is generated based on:
generating a plurality of positive item pairs based on a plurality of co-purchase item pairs from the plurality of transactions;
for each positive item pair (q, v) and each user u of the plurality of users, generating a triplet (q, v, u) and its corresponding negative samples (q′, v′), wherein:
q represents a query item in the positive item pair,
v represents a recommendation item in the positive item pair,
q′ represents an item that is not purchased by u,
v′ represents an item that is not co-purchased with q by u;
generating an initial item embedding for each item of the set of items as a Gaussian distribution with a random mean vector and a random covariance matrix;
computing a total loss function based on item embeddings for each triplet (q, v, u) and its corresponding negative samples (q′, v′); and
minimizing the total loss function to find an optimized mean vector and an optimized covariance matrix for each item of the set of items.

3. The system of claim 2, wherein:
each of the plurality of co-purchase item pairs is a heterogeneous item pair including two items belonging to two different products respectively.

4. The system of claim 2, wherein:
the mean vector of each item represents a location of the item in the embedding space with a maximum density; and
the non-zero covariance matrix of each item represents a non-zero variation in a co-purchase behavior of the item.

5. The system of claim 2, wherein computing the total loss function comprises:
for each positive item pair (q, v) and its corresponding negative sample v′, computing a first expected likelihood as an inner product of two item embeddings of items q and v, and computing a second expected likelihood as an inner product of two item embeddings of items q and v′;
based on the first expected likelihood and the second expected likelihood, computing a max-margin loss function with a predetermined margin for each positive item pair (q, v) and its corresponding negative sample v′; and
computing the total loss function based on the max-margin loss functions for every user, every positive item pair (q, v) and its corresponding negative sample v′.

6. The system of claim 5, wherein computing the total loss function further comprises:
for each user u, each query item q, and its corresponding negative sample q′, computing a first personalization loss function based on (u, q, q′);
for each user u, each recommendation item v, and its corresponding negative sample v′, computing a second personalization loss function based on (u, v, v′); and
computing the total loss function based on a summation of: the max-margin loss function, the first personalization loss function and the second personalization loss function.

7. The system of claim 1, wherein the at least one processor is further configured to read the instructions to evaluate the trained model based on:
generating a plurality of positive item pairs based on a plurality of co-purchase item pairs from the plurality of transactions, wherein each of the plurality of co-purchase item pairs is a heterogeneous item pair including two items belonging to two different products respectively; and
for each positive item pair (vi, vj),
computing a first frequency of co-purchases of items vi and vj,
computing a second frequency of co-purchases including item vi,
computing a third frequency of co-purchases including item vj,
computing a contingency table based on: the first frequency, the second frequency and the third frequency,
computing an expectation table based on: a total number of observed co-purchases in the plurality of transactions, the second frequency and the third frequency,
computing a value of a Chi-squared statistics based on the contingency table and the expectation table,
comparing the value to a threshold,
comparing the first frequency to an expected frequency under an independence assumption, and
determining that the positive item pair (vi, vj) is a labeled item pair that is trustworthy for evaluation of the trained model, when both (a) the value is larger than the threshold and (b) the first frequency is larger than the expected frequency.

8. The system of claim 7, wherein:
a purchase of each individual item is represented by a random variable following a Bernoulli distribution; and
the threshold is associated with a p-value of a Chi-squared distribution with one degree of freedom.

9. The system of claim 7, wherein the trained model is evaluated further based on:
generating a set of labeled item pairs from the plurality of positive item pairs;
for each labeled item pair (ql, vl),
computing top K complementary items for the item ql based on the trained model, wherein K is a positive integer,
computing metrics to evaluate the trained model when the item vl is among the top K complementary items; and
aggregating the metrics over all labeled item pairs to evaluate performance of the trained model.

10. A computer-implemented method, comprising:
generating a trained model based on transaction data identifying a plurality of transactions of a plurality of users;
representing each item of a set of items as an item embedding in an embedding space based on the trained model, wherein the item embedding is a Gaussian distribution with a mean vector and a non-zero covariance matrix;
determining an anchor item to be displayed to a user via a user interface executed on a user device of the user;
representing the anchor item as an anchor embedding in the embedding space based on the trained model, wherein the anchor embedding is a Gaussian distribution with an anchor mean vector and an anchor non-zero covariance matrix;
computing a complementarity score for each item of the set of items, based on a distance between the mean vector of the item and the anchor mean vector;
generating a ranking for the set of items based on their respective complementarity scores;
selecting a plurality of top items in the set of items based on the ranking as recommended complementary items; and
transmitting information about the recommended complementary items to the user device to be displayed with the anchor item on the user interface.

11. The computer-implemented method of claim 10, wherein generating the trained model comprises:
generating a plurality of positive item pairs based on a plurality of co-purchase item pairs from the plurality of transactions;
for each positive item pair (q, v) and each user u of the plurality of users, generating a triplet (q, v, u) and its corresponding negative samples (q′, v′), wherein:
q represents a query item in the positive item pair,
v represents a recommendation item in the positive item pair,
q′ represents an item that is not purchased by u,
v′ represents an item that is not co-purchased with q by u;
generating an initial item embedding for each item of the set of items as a Gaussian distribution with a random mean vector and a random covariance matrix;
computing a total loss function based on item embeddings for each triplet (q, v, u) and its corresponding negative samples (q′, v′); and
minimizing the total loss function to find an optimized mean vector and an optimized covariance matrix for each item of the set of items.

12. The computer-implemented method of claim 11, wherein:
each of the plurality of co-purchase item pairs is a heterogeneous item pair including two items belonging to two different products respectively;
the mean vector of each item represents a location of the item in the embedding space with a maximum density; and
the non-zero covariance matrix of each item represents a non-zero variation in a co-purchase behavior of the item.

13. The computer-implemented method of claim 11, wherein computing the total loss function comprises:
for each positive item pair (q, v) and its corresponding negative sample v′, computing a first expected likelihood as an inner product of two item embeddings of items q and v, and computing a second expected likelihood as an inner product of two item embeddings of items q and v′;
based on the first expected likelihood and the second expected likelihood, computing a max-margin loss function with a predetermined margin for each positive item pair (q, v) and its corresponding negative sample v′;
for each user u, each query item q, and its corresponding negative sample q′, computing a first personalization loss function based on (u, q, q′);
for each user u, each recommendation item v, and its corresponding negative sample v′, computing a second personalization loss function based on (u, v, v′); and
computing the total loss function based on a summation of: the max-margin loss function, the first personalization loss function and the second personalization loss function.

14. The computer-implemented method of claim 10, further comprising evaluating the trained model based on:
generating a plurality of positive item pairs based on a plurality of co-purchase item pairs from the plurality of transactions, wherein each of the plurality of co-purchase item pairs is a heterogeneous item pair including two items belonging to two different products respectively; and
for each positive item pair (vi, vj),
computing a first frequency of co-purchases of items vi and vj,
computing a second frequency of co-purchases including item vi,
computing a third frequency of co-purchases including item vj,
computing a contingency table based on: the first frequency, the second frequency and the third frequency,
computing an expectation table based on: a total number of observed co-purchases in the plurality of transactions, the second frequency and the third frequency,
computing a value of a Chi-squared statistics based on the contingency table and the expectation table,
comparing the value to a threshold,
comparing the first frequency to an expected frequency under an independence assumption, and
determining that the positive item pair (vi, vj) is a labeled item pair that is trustworthy for evaluation of the trained model, when both (a) the value is larger than the threshold and (b) the first frequency is larger than the expected frequency.

15. The computer-implemented method of claim 14, wherein evaluating the trained model further comprises:
generating a set of labeled item pairs from the plurality of positive item pairs;
for each labeled item pair (ql, vl),
computing top K complementary items for the item ql based on the trained model, wherein K is a positive integer,
computing metrics to evaluate the trained model when the item vl is among the top K complementary items; and
aggregating the metrics over all labeled item pairs to evaluate performance of the trained model.

16. A non-transitory computer readable medium having instructions stored thereon, wherein the instructions, when executed by at least one processor, cause a device to perform operations comprising:
generating a trained model based on transaction data identifying a plurality of transactions of a plurality of users;
representing each item of a set of items as an item embedding in an embedding space based on the trained model, wherein the item embedding is a Gaussian distribution with a mean vector and a non-zero covariance matrix;
determining an anchor item to be displayed to a user via a user interface executed on a user device of the user;
representing the anchor item as an anchor embedding in the embedding space based on the trained model, wherein the anchor embedding is a Gaussian distribution with an anchor mean vector and an anchor non-zero covariance matrix;
computing a complementarity score for each item of the set of items, based on a distance between the mean vector of the item and the anchor mean vector;
generating a ranking for the set of items based on their respective complementarity scores;
selecting a plurality of top items in the set of items based on the ranking as recommended complementary items; and
transmitting information about the recommended complementary items to the user device to be displayed with the anchor item on the user interface.

17. The non-transitory computer readable medium of claim 16, wherein generating the trained model comprises:
generating a plurality of positive item pairs based on a plurality of co-purchase item pairs from the plurality of transactions;
for each positive item pair (q, v) and each user u of the plurality of users, generating a triplet (q, v, u) and its corresponding negative samples (q′, v′), wherein:
q represents a query item in the positive item pair,
v represents a recommendation item in the positive item pair,
q′ represents an item that is not purchased by u,
v′ represents an item that is not co-purchased with q by u;
generating an initial item embedding for each item of the set of items as a Gaussian distribution with a random mean vector and a random covariance matrix;
computing a total loss function based on item embeddings for each triplet (q, v, u) and its corresponding negative samples (q′, v′); and
minimizing the total loss function to find an optimized mean vector and an optimized covariance matrix for each item of the set of items.

18. The non-transitory computer readable medium of claim 17, wherein:
each of the plurality of co-purchase item pairs is a heterogeneous item pair including two items belonging to two different products respectively;
the mean vector of each item represents a location of the item in the embedding space with a maximum density; and
the non-zero covariance matrix of each item represents a non-zero variation in a co-purchase behavior of the item.

19. The non-transitory computer readable medium of claim 17, wherein computing the total loss function comprises:
for each positive item pair (q, v) and its corresponding negative sample v′, computing a first expected likelihood as an inner product of two item embeddings of items q and v, and computing a second expected likelihood as an inner product of two item embeddings of items q and v′;
based on the first expected likelihood and the second expected likelihood, computing a max-margin loss function with a predetermined margin for each positive item pair (q, v) and its corresponding negative sample v′;
for each user u, each query item q, and its corresponding negative sample q′, computing a first personalization loss function based on (u, q, q′);
for each user u, each recommendation item v, and its corresponding negative sample v′, computing a second personalization loss function based on (u, v, v′); and
computing the total loss function based on a summation of: the max-margin loss function, the first personalization loss function and the second personalization loss function.

20. The non-transitory computer readable medium of claim 16, wherein the instructions, when executed by at least one processor, further cause the device to perform:
generating a plurality of positive item pairs based on a plurality of co-purchase item pairs from the plurality of transactions, wherein each of the plurality of co-purchase item pairs is a heterogeneous item pair including two items belonging to two different products respectively;
generating a set of labeled item pairs from the plurality of positive item pairs based on: for each positive item pair (vi, vj),
computing a first frequency of co-purchases of items vi and vj,
computing a second frequency of co-purchases including item vi,
computing a third frequency of co-purchases including item vj,
computing a contingency table based on: the first frequency, the second frequency and the third frequency,
computing an expectation table based on: a total number of observed co-purchases in the plurality of transactions, the second frequency and the third frequency,
computing a value of a Chi-squared statistics based on the contingency table and the expectation table,
comparing the value to a threshold,
comparing the first frequency to an expected frequency under an independence assumption, and
determining that the positive item pair (vi, vj) is a labeled item pair that is trustworthy for evaluation of the trained model, when both (a) the value is larger than the threshold and (b) the first frequency is larger than the expected frequency;
for each labeled item pair (ql, vl),
computing top K complementary items for the item ql based on the trained model, wherein K is a positive integer,
computing metrics to evaluate the trained model when the item vl is among the top K complementary items; and
aggregating the metrics over all labeled item pairs to evaluate performance of the trained model.
